(19) United States
(12) Patent Application Publication
(10) Pub. No.: US 2023/0264198 A1
(43) Pub. Date: Aug. 24, 2023

(54) PARTICLE MOVEMENT IN CHANNEL RESPONSIVE TO MAGNETIC FIELD

(71) Applicant: Analog Devices International Unlimited Company, Limerick (IE)

(72) Inventors: Alan J. O'Donnell, Castletroy (IE); Jan Kubík, Limerick (IE); Jochen Schmitt, Biedenkopf (DE); Stanislav Jolondcovschi, Carlow (IE); Shaun Bradley, Patrickswell (IE); Gavin Patrick Cosgrave, Enniscorthy (IE); Alfonso Berduque, Crusheen (IE); Javier Calpe Maravilla, Algemesi (ES); Padraig L. Fitzgerald, Mallow (IE); Eoin Edward English, Pallasgreen (IE); Michael P. Lynch, Bruff (IE)

(21) Appl. No.: 18/170,765

(22) Filed: Feb. 17, 2023

Related U.S. Application Data
(60) Provisional application No. 63/268,350, filed on Feb. 22, 2022.

(51) Int. Cl. B01L 3/00

(52) U.S. Cl. CPC B01L 3/502761; B01L 3/50851; B01L 2200/0647; B01L 2300/023; B01L 2300/0663; B01L 2300/0861; B01L 2300/18; B01L 2400/043; B01L 2400/08

(57) ABSTRACT

Aspects of this disclosure relate to systems that include a channel with at least one fluid in particle in fluid. The at least one particle can move along a defined path of the channel in response to a magnetic field. At least one structure is integrated with the channel, such as a sensor to generate an output signal related to the magnetic field or a magnetic structure to apply the magnetic field. Relates methods are also disclosed.

### CROSS REFERENCE TO PRIORITY APPLICATION

Any and all applications for which a foreign or domestic priority claim is identified in the Application Data Sheet as filed with the present application are hereby incorporated by reference under 37 C.F.R. § 1.57. This application claims the benefit of priority of U.S. Provisional Application No. 63/268,350, filed Feb. 22, 2022 and titled “PARTICLE MOVEMENT IN CHANNEL RESPONSIVE TO MAGNETIC FIELD,” the disclosure of which is hereby incorporated by reference in its entirety and for all purposes.

### BACKGROUND

### Technical Field

The disclosed technology relates to particle movement in a channel in response to a magnetic stimulus.

### Description of Related Technology

Fluid can flow through channels in a variety of applications. Particles can be included in the fluid. Moving the fluid though a channel is useful in a variety of applications and for a variety of purposes.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a system with particle movement and magnetic field sensing. The system includes a channel and a sensor that is integrated with the channel. The channel includes a fluid and at least one particle in the fluid. The at least one particle moves along a defined path of the channel in response to a magnetic field. The sensor is configured to generate an output signal related to the magnetic field.

The at least one particle can include a magnetically sensitive particle. The fluid can be a magnetically sensitive fluid.

The system can include a measurement circuit configured to generate a measurement is indicative of a number of turns of the magnetic field based on the output signal, where the number of turns is greater than one and the channel is spiral shaped. The channel can be a closed loop. The channel can be an open loop. The system can include a permanent magnet connected to a rotatable shaft.

The output signal can be indicative of a cumulative exposure to the magnetic field. The output signal can be indicative of position of the at least one particle.

The system can include a magnetic structure integrated with the channel and an integrated circuit that is integrated with the channel. The integrated circuit can be configured to control flow of the at least one particle in the channel by at least providing a signal to the magnetic structure. The magnetic structure can have a meander shape. The magnetic structure can include a conductive structure positioned around the channel.

The sensor can include a magnetic structure. The sensor can include an optical sensor. The sensor can include a capacitive sensor. The sensor can include a microelectromechanical systems device.

The system can include a heating structure integrated with the channel. The system can include a piezoelectric structure integrated with the channel.

The system can include an antenna configured to transmit information associated with the output signal of the sensor.

Another aspect of this disclosure is a method of measuring one or more particles that move in response to a magnetic stimulus. The method includes providing a channel comprising a fluid and one or more particles in the fluid, wherein the one or more particles move along a defined path of the channel in response to an applied magnetic field; and generating a measurement related to the one or more particles based on an output of a sensor that is integrated with the channel.

The channel can be spiral shaped. The measurement can be indicative of a number of turns of the applied magnetic field. The number of turns is greater than one.

The measurement can be indicative of a cumulative exposure to the applied magnetic field.

The measurement can be indicative of position of the one or more particles.

The method can include controlling flow of the one or more particles in the channel by at least providing a signal to a magnetic structure that is integrated with the channel. The magnetic structure can have a meander shape. The method can include controlling flow of the fluid in the channel as part of an analytic process, wherein the measurement is indicative of progress of the analytic process; and wirelessly transmitting the measurement via at least one antenna. The fluid can be controlled by agitation, a piezoelectric element, heating, filtering, or the like.

The sensor can include a magnetically sensitive structure that is integrated with the channel.

Another aspect of this disclosure is a system with particle movement in response to a magnetic stimulus. The system includes a channel including a fluid and at least one particle in the fluid and a magnetic structure integrated with the channel. The magnetic structure includes a meander shape. The magnetic structure is configured to apply a gradient magnetic field to cause the at least one particle to move in the channel.

The system can include a sensor integrated with the channel, where the sensor is configured to generate an output signal related to the gradient magnetic field. The sensor can include a magnetic sensor. The sensor can include an optical sensor.

The system can include a heating element integrated with the channel. The heating element can apply heat to the fluid.

The system can include a piezoelectric element integrated with the channel. The piezoelectric element can physically agitate the at least one particle in the fluid.

The channel can branch into a plurality of sub-channels to distribute a plurality of particles that include the at least one particle.

A plurality of sub-channels can feed into the channel to concentrate a plurality of particles that include the at least one particle.

The at least one particle can be a magnetically sensitive particle. The fluid can be a magnetically sensitive fluid.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting example, with reference to the accompanying drawings.

FIGS. 1A and 1B are schematic plan views of channels with magnetically sensitive particles in fluid according to embodiments.

FIG. 2A is a schematic isometric view of a substrate containing one or more channels with magnetically sensitive particles in fluid and a magnetic structure on the substrate according to an embodiment. FIG. 2B illustrates examples of magnetic material patterns for the magnetic structure on the substrate of FIG. 2A. FIG. 2C illustrates examples of coils for antennas that can be implemented on the substrate of FIG. 2A. FIGS. 2D and 2E illustrate examples of a meander structure and a coil structure, respectively, where either or both of these structures can be implemented on the substrate of FIG. 2A.

FIGS. 3A, 3B, 3C, 3D, and 3E are example plan views of channels and integrated magnetic structures according to embodiments.

FIG. 4 illustrates example isometric views and a side/cross-sectional view of a meander structure integrated with a channel according to embodiments.

FIG. 5 illustrates example views of a conductive structure integrated with and positioned about a channel according to an embodiment.

FIGS. 6A, 6B, 6C, and 6D illustrate example magnetic structures positioned about a channel according to embodiments.

FIG. 7A is a schematic diagram of a system with closed loop channels for multi-turn magnetic sensing according to an embodiment. FIG. 7B is a schematic diagram of a system with multi-turn magnetic sensing with closed loop channels and a sensor array according to an embodiment.

FIG. 8A is a schematic diagram of a system with an open loop channel for multi-turn magnetic sensing according to an embodiment.

FIG. 8B is a schematic diagram of a closed loop channel for multi-turn magnetic sensing according to an embodiment.

FIG. 8C is a schematic diagram of a channel with structures for detecting magnetic particles and reservoirs for holding magnetic particles in a system for multi-turn magnetic sensing according to an embodiment.

FIG. 8D is a schematic diagram of a channel for multi-turn magnetic sensing that includes valves according to an embodiment.

FIGS. 9A and 9B are cross-sectional schematic diagrams with magnetically sensitive particles in channels with integrated detection according to embodiments.

FIG. 10A is a schematic diagram of system that includes magnetically sensitive particles flowing through a channel with a plurality of chambers according to an embodiment. FIG. 10B is a schematic diagram corresponding to one chamber of FIG. 10A.

FIG. 11A is a schematic diagram of a printed circuit board or laminate/build up structure and a controller with channels and optical sensing of magnetic particles according to an embodiment. FIG. 11B is a schematic cross-sectional view of a system with mechanical and optical detection in chambers embedded within a substrate.

FIG. 12A is a schematic diagram of a channel with an integrated element to move magnetically sensitive particles and an integrated sensing element according to an embodiment.

FIG. 12B is a schematic diagram of a channel with an integrated agitation element to agitate fluid in the channel and an integrated sensing element according to an embodiment.

FIG. 12C is a schematic diagram of a channel having a channel structure that agitates fluid in the channel and an integrated sensing element according to an embodiment.

FIG. 12D is a schematic diagram of a channel with a plurality of integrated structures according to an embodiment.

FIG. 12E is a schematic diagram of a channel with a plurality of integrated structures according to another embodiment.

FIGS. 13A and 13B illustrate a schematic diagram of a system with cumulative magnetic field exposure detection according to an embodiment.

FIG. 14 is a schematic diagram of a device that can separate magnetically sensitive particles into different channels.

FIGS. 15A, 15B, and 15C are schematic diagrams of channels providing various defined paths for magnetically sensitive particles.

FIG. 16 includes schematic and timing diagrams related to generating a magnetic field gradient for moving magnetically sensitive particles.

FIG. 17A is a schematic diagram of a channel structure to guide and concentrate magnetically sensitive particles. FIG. 17B is a schematic diagram of a channel structure to guide and distribute magnetically sensitive particles.

FIGS. 18A and 18B are schematic diagrams of a system with a channel and an integrated structure according to an embodiment.

FIGS. 19A to 19D are schematic diagrams of a system with channels and an integrated structure according to an embodiment.

FIG. 20A is a schematic plan view of a channel with a sensor and a meander structure according to an embodiment. FIG. 20B is a schematic cross-sectional view of a channel with an integrated structure and a structure deposited on or integrated with a cap according to an embodiment.

FIG. 21 is a schematic isometric diagram of system with a heating element integrated with a channel according to an embodiment.

FIG. 22 is a schematic isometric diagram of system with a piezoelectric element integrated with a channel according to an embodiment.

FIGS. 23A and 23B are schematic isometric exploded diagrams of systems with heating elements on opposing sides of a substrate with one or more channels according to embodiments.

FIGS. 24A and 24B are schematic isometric and cross-sectional views of example channels with a plurality of integrated structures according to an embodiment.

FIGS. 25A, 25C, 25D, 25E, and 25F are schematic views of example channels with integrated conductive structures or sensors according to embodiments. FIG. 25B illustrates example conductive structure.

FIGS. 26A, 26B, 26C, and 26D are schematic diagrams of systems with a channel and an agitation or mixing element according to embodiments.

FIGS. 27A and 27B are schematic views of example vertical channel arrays with integrated filters or covers according to embodiments.

FIG. 28A illustrates example shapes of magnetically sensitive particles. FIG. 28B illustrates example combined structures with magnetically sensitive particles included within non-magnetic material. FIG. 28C shows examples of clusters of particles.

FIG. 29A is a schematic side or cross-sectional view of a system-in-a-package (SIP) that includes a channel according to an embodiment. FIG. 29B is a schematic plan view of the SIP of FIG. 29A.

FIG. 30 is a schematic side or cross-sectional view of a SIP that includes a channel according to an embodiment.

FIG. 31 includes a side view of a system with a moving magnet, a channel with magnetically sensitive particles, and integrated sensors according to an embodiment.

FIG. 32 includes views of a channel with magnetically sensitive particles in an embedded system according to an embodiment.

FIG. 33 is an exploded schematic view of an example system with a channel with magnetically sensitive particles and wireless communication according to an embodiment.

FIGS. 34A and 34B include views of example substrates with channels according to embodiments.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings. The headings provided herein are for convenience only and do not necessarily affect the scope or meaning of the claims.

Aspects of this disclosure relate to a channel with at least one magnetically sensitive particle in fluid. The magnetically sensitive particle can move along a defined path of the channel in response to a magnetic stimulus. A sensor that is integrated with the channel can generate a measurement and/or electrical signal related to the magnetic field and/or the one or more magnetically sensitive particles. For example, the measurement related to the magnetic field can be indicative of one or more of location of one or more magnetically particles after exposure to the magnetic field, time of exposure to a magnetic field, intensity of a magnetic field, location of a magnetic field, direction of a magnetic field, angle of a magnetic field, number of rotations of a magnetic field, time domain change in a magnetic field (e.g., frequency and/or harmonics), or the like. Some example applications include one or more spiral channels for detecting multiple rotations of a magnetic field and cumulative magnetic field exposure detection. A magnetic structure integrated with the channel can apply the magnetic field to move the at least one magnetically sensitive particle along the path. In certain applications, a heating element and/or a piezoelectric structure can also be integrated with the channel.

Aspects of this disclosure relate to a channel with at least one magnetically sensitive particle in fluid and a structure integrated with the channel. The structure can include a magnetic structure comprising a meander shape configured to cause the at least one magnetically sensitive particle to move in the channel. Such a magnetic structure with a meander shape can apply a gradient magnetic field. The structure integrated with the channel can include a magnetic sensing structure configured to sense the at least one magnetically sensitive particle. The structure can include a heating element configured to apply heat to the fluid. The structure can include a piezoelectric element configured to physically agitate the at least one magnetically sensitive particle in the fluid.

Embodiments disclosed herein can achieve advantages over other devices, systems, modules, or the like. Integrated solutions with sensing of magnetically sensitive particles in a channel are provided. Such solutions can generate measurements without external sensors and/or be implemented in a compact physical space. Structures integrated with a channel containing magnetically sensitive structures and/or particles can provide advantages related to one or more of controlling particle movement, heating fluid, physically agitating particles, interacting directly with the fluid, or the like.

In applications where relatively small amounts of fluid are analyzed, the ability to manipulate a sample may be desirable. At a micro level, agitating, mixing, and/or segregating magnetically sensitive particles in a fluid at specific points of a channel can be desired as part of a process to refine a sample for analysis. In certain applications, applying heat to specific areas may also be desirable. Embodiments described herein relate to different techniques that can be combined and applied as desired. Certain embodiments also include elements that can dynamically change the way in which a fluid is manipulated. Different elements shown within embodiments within this document can be selected and combined depending on the specifications of a particular application.

### Channels With Particles in Fluid

A channel can include one or more magnetically sensitive particles within a fluid. The magnetically sensitive particles and the fluid can be selected such that the magnetically sensitive particles can move within the channel in response an applied magnetic field. The magnetically sensitive particles can move in a detectable manner. The magnetically sensitive particles can be implemented with any suitable principles and advantages of the particles disclosed herein. The magnetically sensitive particles can be electrically conductive in certain applications. The magnetically sensitive particles can move along a defined path of the channel in response to a magnetic stimulus. The defined path can be based on the structure and/or shape of the channel. The defined path can be based on one or more of a direction, location, intensity, or the like of an applied magnetic field. The direction of magnetic particle movement can be based on a property of magnetically sensitive material of the particles, such as whether the magnetically sensitive particles are attracted or repelled by a magnetic field. The magnetic stimulus can be an external magnetic field. The magnetic stimulus can be generated by a structure integrated with the channel, such as a conductive meander structure.

The fluid can be a liquid or a gel having a viscosity suitable to facilitate movement of magnetically sensitive particles within the channel such that the movement of the magnetically sensitive particles can be detected. The fluid can have a suitable density and viscosity based on a desired range of measurement for a particular application. The fluid can have a dilation constant that is relatively small such that there are no significant technical challenges with forcing the channel when temperature drifts.

Example fluids include without limitation aqueous solutions (e.g., buffers, aqueous electrolytes, aqueous solutions with conductive salts, aqueous solutions without conductive salts, pH buffers, salts in water, etc.), organic solutions (e.g., oils or organic solvents), aqueous or organic gels (e.g., a hydrogel, PVC, polyacrylic acid, a polyvinylalcohol gel, a polydimethylsiloxane gel, agarose-PBS, a PVC gel in organic solvents such as 2-nitrophenyl octyl ether, etc.), a wax, a conductive polymer (e.g., PEDOT, Nafion dispersions, etc.), water, an alcohol, an oil, or a fluid that allows Brownian motion of magnetically sensitive particles within the fluid.

In some instances, the fluid can change viscosity and/or state in response to a change in temperature, for example, as described in U.S. Pat. App. No. 18/053,523 filed Nov. 8, 2022, the disclosure of which is hereby incorporated by references in its entirety and for all purposes. Any suitable principles and advantages of particles in a medium material and/or a phase change material disclosed in U.S. Pat. App. No. 63/263,978 can be implemented in accordance with any suitable principles and advantages disclosed herein.

A sensor can detect the magnetically sensitive particles within the channel. Position and/or movement of the magnetically sensitive particles can be detected with magnetic sensing, optical sensing, with capacitive sensing, with microelectromechanical systems (MEMS) based sensing, or the like. Any suitable principles and advantages disclosed herein can be used in biomedical applications, such as biomedical applications related to sensing magnetotactic bacteria. Sensing can be performed in accordance with any suitable principles and advantages discussed below and/or disclosed in U.S. Pat. App. No. 17/933,600 filed Sep. 20, 2022, the disclosure of which is hereby incorporated by reference in its entirety herein and for all purposes. Sensing can provide a variety of useful measurements. The shape, size, and/or dimensions of the channels can be modified and/or optimized as desired depending on the size of the particles and/or specifications of a particular application. For example, as a result of an external (magnetic) stimulus, a magnetic particle may move along a specific channel. This movement can be detected through an output signal.

A sensor can provide an output signal indicative of a magnetic field. Such an output signal can provide an indication of one or more of time of exposure to a magnetic field, intensity of a magnetic field, location of a magnetic field, direction of a magnetic field, angle of a magnetic field, number of rotations of a magnetic field, time domain change in a magnetic field (e.g., frequency and/or harmonics), or the like.

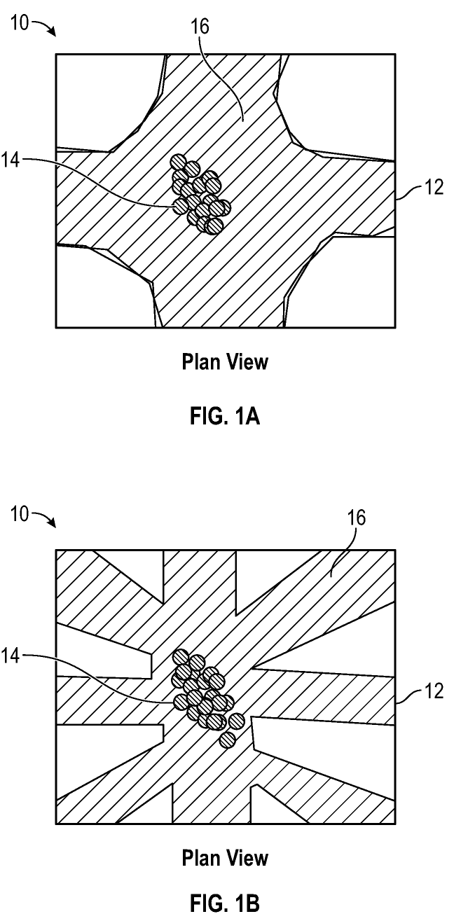

FIGS. 1A and 1B are schematic plan views of substrates 10 with channels 12 and magnetically sensitive particles 14 in fluid 16 according to embodiments. The substrate 10 can be any suitable substrate, such as a glass substrate, a ceramic substrate, a silicon substrate, a metal substrate, or a plastic substrate, etc. FIGS. 1A and 1B illustrate different channels 12. The channels 12 can be microfluidic channels. The channels 12 can be tracks. The channels 12 can be arranged such that the magnetically sensitive particles 14 move along a defined path. This can facilitate concentrating and/or moving the magnetically sensitive particles 14 to a specific region or location such that there is a discernible method of detection.

The magnetically sensitive particles 14 can include one or more of the following materials: iron, cobalt, nickel, graphite, chromium, or any suitable alloy thereof. The magnetically sensitive particles 14 can include one or more of the following materials: Heusler alloys or chromium oxide. In certain applications, magnetically sensitive particles 14 can include polystyrene (PS) magnetic particles. Polystyrene magnetic particles can be synthesized by embedding superparamagnetic iron oxide into polystyrene. Polystyrene magnetic particles can be positively charged (e.g., by amine modification), unmodified, or negatively changed (e.g., by carboxyl modification). In some applications, magnetically sensitive particles can include streptavidin coated magnetic particles.

A magnetic field can move the magnetically sensitive particles 14 along the channel 12. In some instances, the magnetic field can be a gradient magnetic field to move the magnetically sensitive particles 14. A homogenous magnetic field can cause the magnetically sensitive particles 14 to attract each other and cluster. In some instances, clustering of the magnetically sensitive particles 14 can be detected.

In some embodiments, a channel can include non-magnetically sensitive particles in a magnetically sensitive fluid. The magnetically sensitive fluid can be a ferromagnetic fluid, a paramagnetic fluid, a diamagnetic fluid, or a magnetorheological fluid. The magnetically sensitive fluid can change density based on the characteristics of an external magnetic field and the particles can then change the depth where they are located within the fluid. The magnetically sensitive fluid can be a magnetorheological fluid that changes mechanical viscosity significantly when exposed to magnetic field. Such a fluid can reduce and/or prevent particle movement when magnetized and allow particle movement in the absence of a magnetic field.

Examples of magnetically sensitive fluids include ferrofluids made with particles of magnetic materials such as magnetite, maghemite or cobalt ferrite dispersed in a fluid, such as water or an organic solvent. The properties of the ferrofluid and density of the particles may be chosen for the specifications of a particular application.

The magnetically sensitive fluid can be liquid. A plurality of different types of non-magnetic particles can be included in the magnetically sensitive fluid. Positions of the different types of non-magnetic particles can be used to measure an applied magnetic field. With magnetic density separation, an indication of an applied magnetic field can be determined based on positions of the non-magnetically sensitive particles. While the particles need not be directly responsive to external magnetic fields, advantageously the particles can be chosen to facilitate sensing their positions when they are moved by the fluid’s response to external magnetic fields. Example materials include non-magnetic conductors (e.g., aluminium, charged particles such as particles with carboxylate or amino groups on the surface making them conductive but not magnetic, etc.), a plastic, foam, polyethylene terephthalate (PET), and silica particles. In certain applications, non-magnetic particles can be non-magnetic polystyrene particles. Non-magnetic polystyrene particles can be positively charged (e.g., by amine modification), unmodified, or negatively charged (e.g., by carboxyl modification). In some applications, non-magnetic particles can include streptavidin coated non-magnetic particles. Non-magnetic particles can be selected based on how they are to be detected in the system. For example, with optical detection, opaque non-magnetic particles can be used. The non-magnetic particles can be mechanically resilient. Systems incorporating optical detection can also incorporate optical vias within channels. Examples of optical windows for optical detection are described herein. In some instances, non-magnetic particles can be electrically conductive. Any suitable principles and advantages of the embodiments described with reference to magnetically sensitive particles can be applied to non-magnetically sensitive particles within a magnetic fluid.

Particles and fluids in channels disclosed herein can be implemented in accordance with any suitable principles and advantages disclosed in U.S. Pat. App. No. 17/933,600 and/or U.S. Pat. App. No. 18/053,523.

### Channels With Integrated Magnetic Structures

One or more magnetic structures can be integrated with a channel. For example, a magnetic sensor can be integrated with the channel. As another example, a magnetic structure configured to generate a magnetic field can be integrated with the channel. There may be an interaction between an external body with a magnetic field and magnetic material on the substrate that can affect magnetic particles in fluid. This interaction can produce a discernible electrical signature or otherwise be detected. The magnetic material on the substrate can interact with the magnetically sensitive particles contained within the channel. This can deliver a sensitivity and/or interaction with an external environment that can be desirable in certain applications. Example magnetic structures that can be integrated with a channel will now be discussed. Any suitable principles and advantages of these magnetic structures can be implemented together with each other.

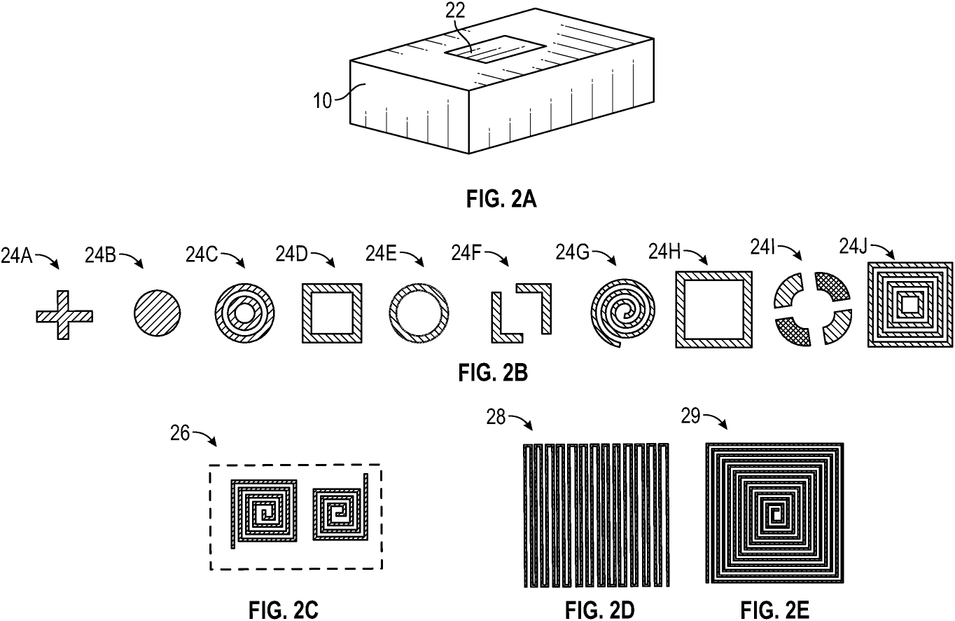

FIG. 2A is a schematic isometric view of a substrate 10 containing one or more channels with magnetically sensitive particles in fluid and a magnetic structure 22 on the substrate 10 according to an embodiment. The magnetic structure 22 can be deposited on the substrate 22. The magnetic structure 22 can be a block of magnetic material, layers of magnetic material, or a pattern of magnetic material. The shape and/or structure of the magnetic structure 22 can be selected/modified for a particular application. Also, the shape, size, and/or construction of the channels contained with the substrate can be enhanced and/or optimized depending on one or more of the particle size, fluid, or specifications of a particular application. FIG. 2B illustrates example magnetic material patterns 24A, 24B, 24C, 24D, 24E, 24F, 24G, 24H, 24I, and 24J for the magnetic structure 22 on the substrate 10 of FIG. 2A.

Conductive structures can also be deposited on and/or integrated with a channel that includes magnetically sensitive particles in a fluid. Such conductive structures can provide signal transmission, manipulate and/or interactive with the magnetically sensitive particles, or the like.

FIG. 2C illustrates examples of coils for antennas 26 that can be implemented on the substrate of FIG. 2A. Such antennas 26 can wireless transmit signals associated with the magnetically sensitive particles and/or a magnetic field applied to the magnetically sensitive particles. In certain applications, an antenna can be included in a radio frequency identification (RFID) tag. As shown in FIG. 2C, a pair of antennas 26 can be implemented. The antennas 26 can be on the substrate 10 of FIG. 2A, for example. In certain applications, energizing of RFID coils may interact with fluid within a channel.

FIG. 2D illustrates an example meander shaped structure 28 that can be implemented on the substrate 10 of FIG. 2A. The magnetic structure 22 of FIG. 2A can have the meander shape shown in FIG. 2D. The meander shaped structure 28 can generate a gradient magnetic field. In certain applications, a gradient magnetic field generated by a meander shaped structure 28 can attract magnetically sensitive particle better than a magnetic field generated by a coil.

FIG. 2E illustrates an example coil shaped structure 29 that can be implemented on the substrate 10 of FIG. 2A. The magnetic structure 22 of FIG. 2A can have the coil shown in FIG. 2E. The coil shaped structure 29 can generate a magnetic field in certain applications.

A magnetic structure can be positioned about a channel. The channel can be a microfluidic channel to route the fluid in a particular or desired direction. Magnetically sensitive particles in fluid in the channel can interact with one or more magnetic structures placed or incorporated with the channel at specific points.

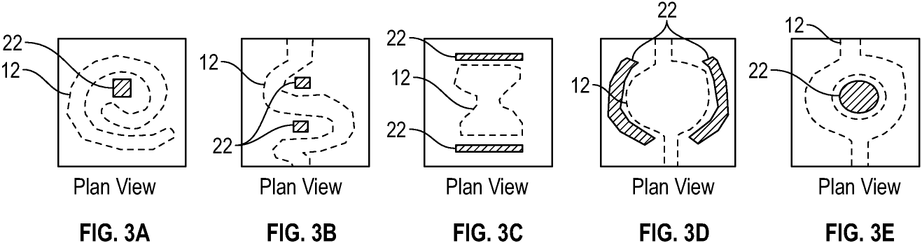

FIGS. 3A to 3E are example plan views of channels 12 and integrated magnetic structures 22 according to embodiments. As shown in FIG. 3A, a channel 12 can wind around a magnetic structure 22. In FIG. 3B, a plurality of magnetic structures 22 are positioned at particular points along a channel 12. This can provide magnetic sensing at particular points along the channel 12. In some instances, the magnetic structures 22 of FIG. 3B can apply a magnetic field at particular points along the channel 12. Magnetic structures 22 can be positioned along opposing sides of a channel 12, for example as shown in FIG. 3C. As shown in FIG. 3D, magnetic structures 22 can be positioned along opposing sides of a channel 12 and be shaped similar to an adjacent part of the channel 12. A magnetic structure 22 can be surrounded by a channel 12, for example, as shown in FIG. 3E.

The magnetic structure 22 can be positioned to monitor or interact with the fluid as desired, depending on the specific application. For example, a measurement or monitoring of a fluid at a specific location (e.g., as part of its progression through a system) can indicate a material state as part of an evolving/maturing process. Such a process can be part of a chemical/maturing process, for example. Magnetic structures 22 can be located at specific locations in a channel 12 measuring the magnetically sensitive particle content of a fluid can be desirable. The positioning of specific magnetic structures 22 at defined locations can enable this. Furthermore, a channel can be constructed such that the channel’s shape, gradient, and/or orientation combined with a magnetic structure 22 can enhance and/or optimize detection and/or segregation of magnetically sensitive particles at specific points. The channel 12 or track can have a shape to enable fluid with magnetically sensitive particles to move in a desired direction or volume that could facilitate the manipulation or analysis desired.

A meander structure of magnetic material can generate a varying magnetic field. Different stacks and combinations of a magnetic structure and a channel can be combined to achieve the desired effect. For example, a meander structure can be implemented in a layer above and below a fluid carrying channel layer. Such structures can be combined with different channels with a plurality of fluids and/or particle sizes and/or other magnetic structures (e.g., magnetic sensors arrays, coils, meandering conductors, etc.) depending on the target application.

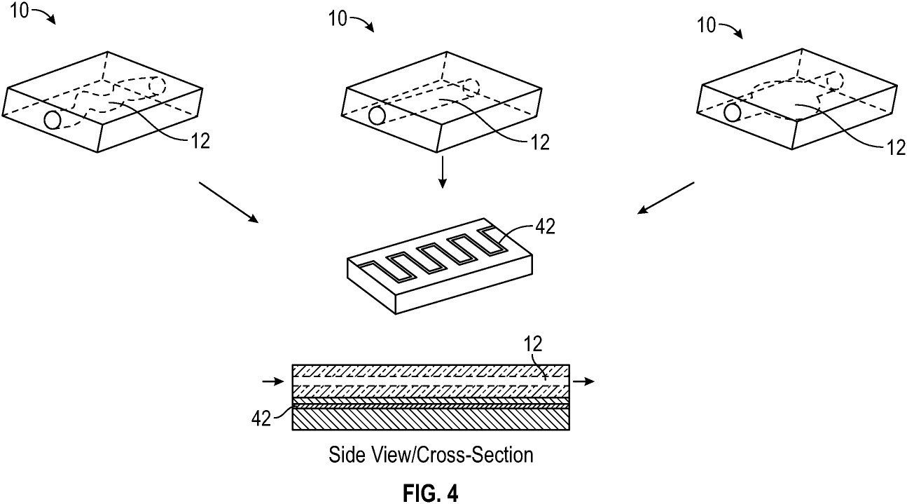

FIG. 4 illustrates example isometric views and a side/cross sectional view of a meander structure integrated with a channel according to embodiments. In FIG. 4, three different channels 12 in a substrate 10 are shown where the channels 12 have different shapes. Each of these channels 12 can include magnetically sensitive particles in a fluid. A meander structure 42 can be formed over the substrate 10. The meander structure 42 can generate varying magnetic field. To apply the varying magnetic field, a current can be applied to the meander structure 42. The varying magnetic field can impart force on magnetically particles within fluid in a channel 12 to move the magnetically sensitive particles.

In some instances, a meander structure can surround a channel. Conductive tracks can be included (e.g., plated, sputtered, etc.) so that a conductive path / 3-dimensional meander structure can surround a channel. A varying magnetic field can be generated by such a meander structure to interact with the channel containing the fluid with magnetically sensitive particles. Different types of conductive structures can be fabricated to meet various system specifications and integrated with channels in different combinations depending on the specifications of a particular application.

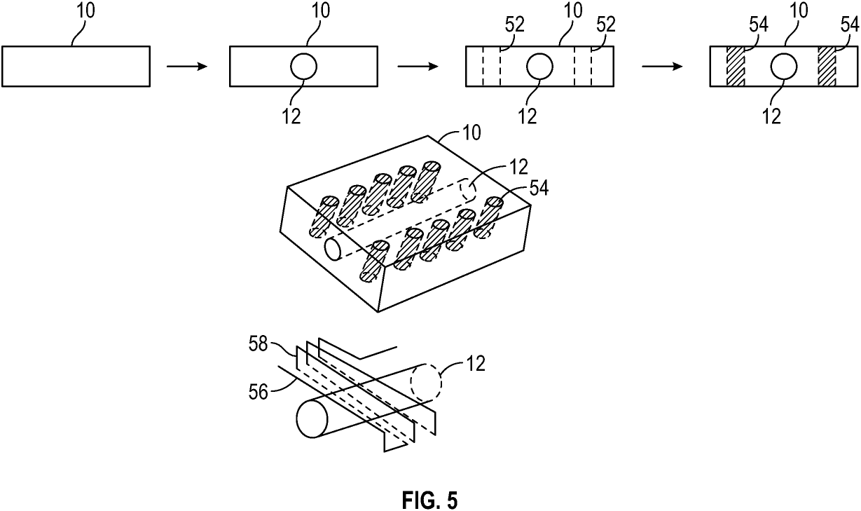

FIG. 5 illustrates example views of a conductive structure integrated with and positioned about a channel 12 according to an embodiment. FIG. 5 illustrates a substrate 10. The substrate 10 can be a glass substrate, a silicon substrate, a ceramic substrate, polymer substrate, or any other suitable substrate. A channel 12, such as a microfluidic channel, can be formed in the substrate 10. Vertical vias 52 can be formed in the substrate 10 around the channel 12. The vias 52 can be filled with conductive material 54. Conductive tracks 56 on opposing sides of the substrate 10 can connect the conductive material 54 in the vias 52 to form a 3-dimensional meander structure 58 around the channel 12. The conductive tracks 56 can be formed by plating, sputtering, printing, or any other suitable process. The meander structure 58 can be formed of any suitable conductive material. The meander structure 58 can apply a gradient magnetic field to move magnetically sensitive particles in fluid along the channel 12.

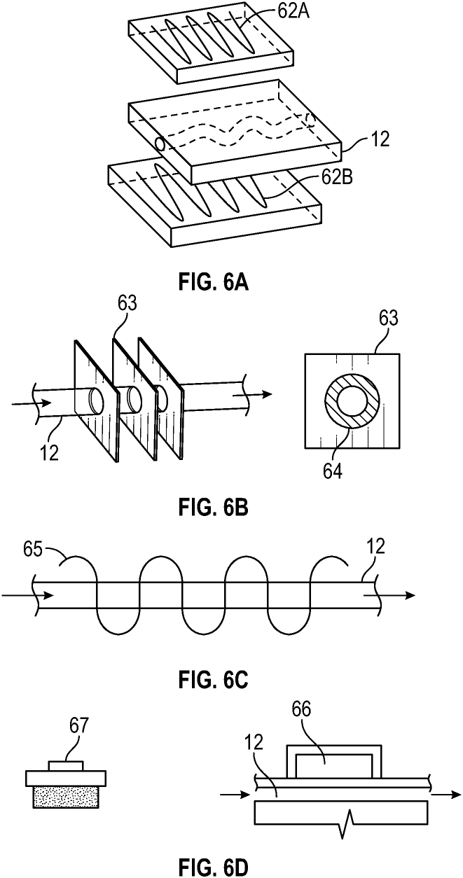

FIGS. 6A to 6D illustrate example magnetic structures positioned about a channel according to embodiments. FIG. 6A illustrates an exploded view of a device with a microfluidic channel 12 positioned between layers with meander structures 62A and 62B configured to create a varying magnetic field. FIG. 6B illustrates a channel 12 with magnetically sensitive particles in fluid and a plurality of foldable or hinge-connected substrates 63 or walls with magnetic structures 64 positioned along the openings through which the channel 12 passes. The substrates 63 can be separate from each other and positioned at intervals along the channel 12. The magnetic structures 64 on the foldable substrates 63 can be any suitable shape or separate walls or sheets (with magnetic structures) placed at different intervals along the channel and optimized depending on the specifications of a particular application. For example, the illustrated magnetic structure 64 is donut shaped. FIG. 6C illustrates a plan view of a microfluidic channel 12 with a meander structure 65 through which the channel 12 passes. FIG. 6D illustrates side or cross-sectional views of a cap 66 over a microfluidic channel 12 that includes magnetically sensitive particles 14 in fluid 16. A magnetic structure 67 can be positioned on the cap 55. FIGS. 6A to 6D show a number of different ways that magnetic structures can be incorporated with fluid carrying channels. The magnetic structures can, for example, be prefabricated on separate substrates and then integrated with tubes or channels or substrates containing channels. The combinations of shapes, structures, integrated layers can be combined as desired depending on the specifications of a particular application.

### Channels With Sensors for Detecting Magnetically Sensitive Particles

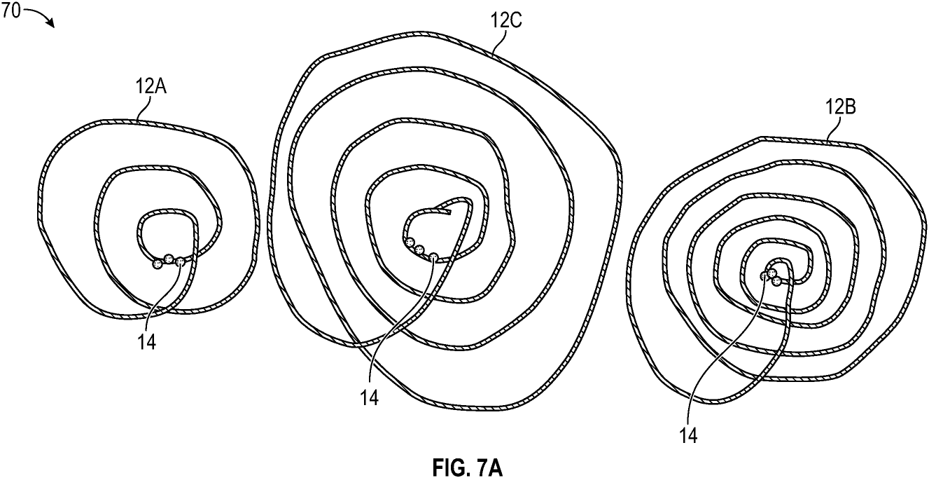

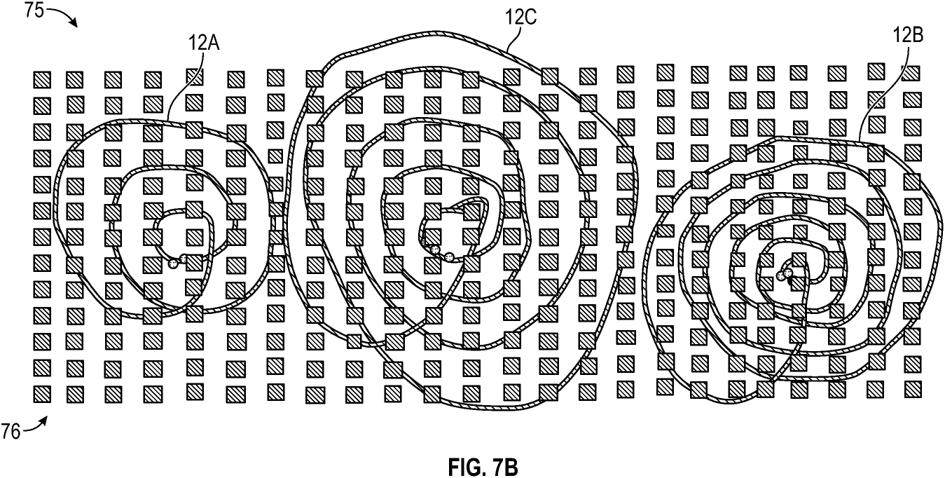

Systems can include a sensor to detect one or more magnetically sensitive particles within the channel. Example systems can detect a number of rotations of a magnetic field, an applied magnetic field, location and/or movement of magnetically sensitive particles, cumulative exposure to a magnetic field, or the like. FIGS. 7A to 13 illustrate example systems in which sensors detect magnetically sensitive particles within a channel. Any suitable principles and advantages of these systems can be implemented together with each other.

In certain embodiments, one or more magnetically sensitive particles can be included within a channel for detecting more than one rotation of a magnetic field. The channel can be spiral shaped. The channel can be a closed loop channel or an open loop channel. The dimensions, shape, and/or one or more other characteristics of the channel can be optimized depending on the specifications of a particular application. A plurality of such channels with a different number of spiral windings or loops can be used to determine a turn count or number of rotations of a magnetic field. As a magnetic field rotates, one or more magnetically sensitive particles move around the spiral channels. The one or more magnetically sensitive particles can move within the channel in either a clockwise or counterclockwise direction depending on the magnet rotation direction. A rotating magnetic field can be generated by a permanent magnet positioned adjacent to (e.g., over) a spiral channel. Such a permanent magnet can be, for example, connected to a rotating shaft.

A sensor or sensor array can detect one or more magnetically sensitive particles within the channel to determine a turn count indicative of a number of rotations of the magnetic field. Example sensor arrays include without limitation a capacitive array, a contact array, and a magnetoresistive sensor array. Such sensing can detect location of magnetically sensitive particles within a channel and/or that magnetically sensitive particles pass certain location(s) in the channel.

Systems arranged to count multiple turns of a magnetic field can be implemented in a variety of applications, such as in rotation counters, encoders for motor control or other absolute multi-turn encoders. Such systems can store an indication of a number of rotations of a magnetic field relative to an initial position. The number of rotations can be relative to any suitable initial position of the magnetic field and the magnetically sensitive particles. The number of turns can be greater than one. The number of turns can have any suitable resolution, such as full turn, half turn, or quarter turn resolution. Multi-turn magnetic sensing can be implemented, for example, in vehicular and/or automotive applications, industrial applications, or the like.

FIG. 7A is a schematic diagram of a system 70 with closed loop channels for multi-turn magnetic field sensing according to an embodiment. As illustrated, the system 70 includes channels 12A, 12B, and 12C each including magnetically sensitive particles 14. The magnetically sensitive particles 14 can be within fluid to facilitate movement within the channels 12A, 12B, and 12C. Although the fluid is not specifically illustrated and labelled in FIG. 7A and some other drawings, any of the channels disclosed herein can include fluid that contains magnetically sensitive particles. The magnetically sensitive particles 14 can be clustered within each of the channels 12A, 12B, and 12C. As a magnetic field rotates, the magnetically sensitive particles 14 move around the closed loop spiral channels 12A, 12B, and 12C. In some instances, a magnet on a rotating shaft can cause rotation of the magnetic field.

Each of the channels 12A, 12B, and 12C has a different number of loops or windings. The different numbers can each be prime numbers in certain applications. With the closed loop channels 12A, 12B, and 12C, the magnetically sensitive particles 14 can continue to move though the loops as the magnetic field rotates beyond the number of loops. Having a different number of loops in the channels 12A, 12B, and 12C can be used to track a relatively large number of turns relative to the number of loops. For example, with three channels having 3, 5, and 7 loops as illustrated, 105 turns can uniquely be determined based on positions of the magnetically sensitive particles within the channels. There are 105 unique combinations of 3, 5, and 7 such that determining how many turns through each of the three channels can detect up to 105 turns. For instance, if the magnetically sensitive particles 14 are positioned so as to indicate 2 turns through the channel with 3 loops, 3 turns through the channel with 5 loops, and 1 turn though the channel with 7 loops, the system can detect 8 rotations of the magnetic field. As another example, with four channels having 3, 5, 7, and 11 loops, 1155 turns can uniquely be determined based on positions of the magnetically sensitive particles within four such channels. The system 70 can also include sensors to detect positions of the magnetically sensitive particles 14 within the channels 12A, 12B, and 12C.

FIG. 7B is a schematic diagram of a system 75 with multi-turn magnetic field sensing with closed loop channels 12A, 12B, and 12C and a sensor array 76 according to an embodiment. The sensor array 76 can detect the magnetically sensitive particles 14 in the channels 12A, 12B, and 12C. The sensor array 76 can include magnetic sensors, capacitive sensors, ultrasound sensors, optical sensors, or any other suitable sensors to detect positions of the magnetically sensitive particles 14 within the channels 12A, 12B, and 12C. Sensors of the sensor array 76 can be positioned on top of and/or underneath the channels 12A, 12B, and 12C. One or more of the type, shape, array size or other aspect(s) of the sensors can be optimized depending on the specifications of a particular application.

In certain applications, the sensor array 76 can include capacitive sensing plates over the channels 12A, 12B, and 12C. There can be a ground plane under such channels 12A, 12B, and 12C. The capacitance from the capacitive sensing plates to ground can be measured using a measurement circuit. The location of the magnetically sensitive particles 14 can be determined by a change in capacitance. The locations can be used to determine a number of turns through the channels 12A, 12B, and 12C. In some instances, there can be an electrostatic reset by moving the magnetically sensitive particles 14 using the sensor array 76.

Magnetically sensitive particles 14 that cluster and move together can facilitate detection. A decoder circuit in communication with a measurement circuit can determine a turn count indicative of a number of rotations of a magnetic field from the locations of the magnetically sensitive particles 14 generated by the measurement circuit. Such decoding is based on outputs of sensors of the sensor array 76. The turn count can represent multiple turns of the magnetic field. The turn count can be determined with quarter turn accuracy, half turn accuracy, full turn accuracy, or any other suitable accuracy.

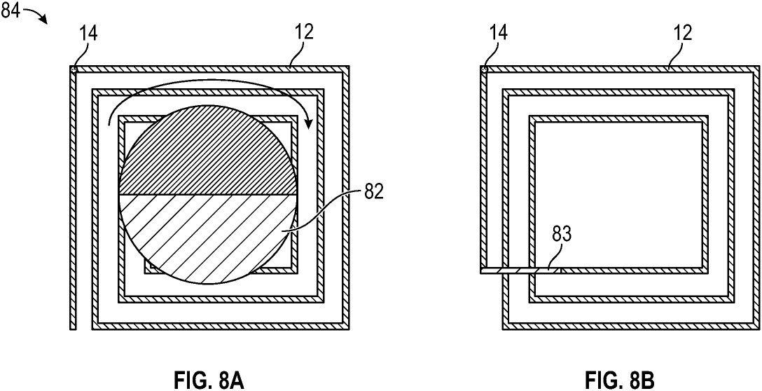

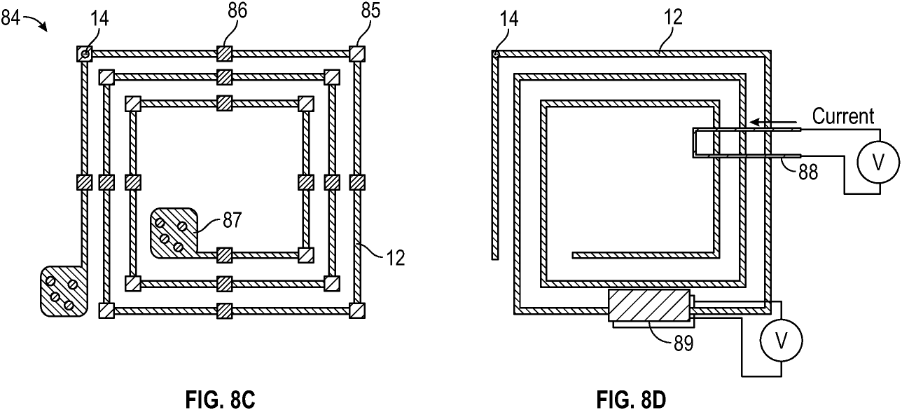

FIG. 8A is a schematic diagram of a top view of a system 80 with an open loop channel 12 for multi-turn magnetic field sensing according to an embodiment. A magnet 82 is positioned relative to the channel 12. Rotation of the magnet 82 causes the magnetically sensitive particle 14 to move along the spiral shaped channel 12. The magnet 82 can be corrected to a rotatable shaft, for example. Although one magnetically sensitive particle 14 is shown in FIG. 8A and some other figures for illustrative purposes, any suitable number of magnetically sensitive particles can be included within a spiral shaped channel for multi-turn sensing. For example, a plurality of magnetically sensitive particles that cluster together can aid in detection in certain applications. A single spiral shaped channel can be used to detect a number of rotations of a magnetic field corresponding to the number of windings of the spiral. Using multiple spiral channels with different numbers of windings or loops can be used to detect a greater number of turns. With sensors, position of the magnetically sensitive particle 14 can be detected to indicate a number of rotations of a magnetic field caused by the magnet 82. One or more of the size, shape, number of turns, etc. of the channel 12 can be optimized depending on the specifications of a particular application.

FIG. 8B is a schematic diagram of a closed loop channel 12 for multi-turn magnetic field sensing according to an embodiment. In certain applications, a closed loop spiral with a connection between a start and an end of spiral at a same level as the rest of the spiral channel can be implemented. This can result in in-place crossings. In some other applications, a closed loop spiral can be implemented with a connection between a start and an end of the spiral channel at a different level as the rest of the spiral. This can result in an overpass or underpass configuration, for example, as illustrated in FIG. 8B. In FIG. 8B, a micro pump 83 is included as part of an overpass or underpass. A micro pump 83 can be located at any suitable location of a spiral channel 12. For instance, a micro pump can be located at transition areas between the spiral levels in certain applications.

The closed loop spiral channel can be implemented with a pump. As part of a spiral channel 12, a micro pump 83, such as a MEMS micro pump can be incorporated at one or more specific locations within the spiral 12 to keep fluid with a magnetically sensitive particle 14 circulating continuously during a period of time. Magnetically sensitive particles can circulate at a different velocity (e.g., faster or slower) depending on the magnetic field rotation direction and rotation rate. With such movement of magnetically sensitive particles within a spiral channel 12, a number of passes of the magnetically sensitive particles 14 per unit time can be counted in one or more locations to detect rotation of a magnetic field. Cumulative rotations can be detected with suitable measurement circuitry in communication with one or more sensors.

FIG. 8C is a schematic diagram of a channel 12 with structures for detecting magnetically sensitive particles and reservoirs for holding magnetically sensitive particles in a system 84 for multi-turn magnetic sensing according to an embodiment. As illustrated in FIG. 8C, a spiral channel 12 can have straight segments and corners. Sensors 85 can be positioned at one or more corners of the spiral channel 12 to detect magnetically sensitive particles 14. As illustrated, sensors 85 can be positioned at each corner of the spiral channel 12. Alternatively or additional, sensors 86 can be positioned at one or more straight segments of the spiral channel 12 to detect magnetically sensitive particles 14. As illustrated, sensors 86 can be positioned at each straight segment of the spiral channel 12. The illustrated sensors can be any suitable sensors to detect the magnetically sensitive particles 14. In certain applications, the spiral channel 12 can incorporate a MEMS micropump capable of moving particles from one reservoir 87 to another reservoir 87 through the spiral channel 12 to perform a reset without magnetic preconditioning. The size and/or shape of the spiral channel 12 and/or one or more of the location, size, number and type of sensors can be optimized depending on the specifications of a particular application.

In certain applications, a reservoir 87 can be included at one or both ends of a spiral channel 12. The reservoir 87 can hold one or more magnetically sensitive particles 14. A valve can release one or more magnetically sensitive particles 14 from the reservoir 87 in certain situations. As one example, a valve can release a magnetically sensitive particle 14 upon another magnetically sensitive particle 14 reaching an end of the spiral channel 12. A valve can be a MEMS type value, an electromagnetic value, an electrostatic valve, or any other suitable valve.

The spiral channel 12 can incorporate a micropump (e.g., a MEMS micropump) operable to move particles 14 from one reservoir 87 to another reservoir 87 through the spiral channel 12. This can perform a reset of the system without magnetic preconditioning.

FIG. 8D is a schematic diagram of a channel 12 for multi-turn magnetic sensing that includes valves 88 and 89 according to an embodiment. One or more suitable valves can be included with any suitable channels disclosed herein. In FIG. 8D, the valves 88 and 89 can hold one or more magnetically sensitive particles 14 in place in the channel 12. An electromagnetic valve 88 can be included with a spiral channel 12. A current strap over and/or under the spiral channel 12 can extend across one or more turns of the spiral channel. Current passing through the strap can create a magnetic field to trap magnetically sensitive particles and hold them in place. This can hold the position of magnetically sensitive particles 14 in a state indicating a number of rotations of a magnetic field. Accordingly, a number of rotations of the magnetic field at a particular time can be captured.

An electrostatic valve 89 can alternatively or additionally be included with the spiral channel 12. The magnetically sensitive particles 14 can carry electric charge in certain applications, and the electrostatic valve 89 can hold the magnetically sensitive particles 14 in place in such applications. Parallel metallic plates positioned adjacent to (e.g., over and/or under, to the left and/or right of) the spiral channel 12 with applied voltage across them can form an electric field. The magnetically sensitive particles 14 can be attracted to one plate or the other plate depending on the polarity of charge they carry. In some instances, both plates can generate an electric field. The electrostatic valve 89 can hold the state of a number of rotations of the magnetic field at a particular time.

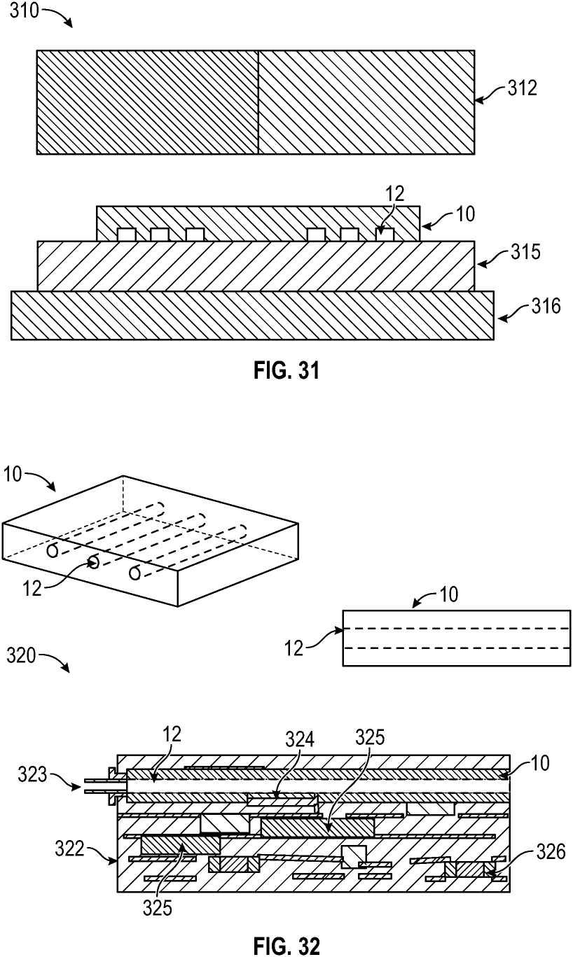

An integrated system for multi-turn magnetic field sensing will be discussed with reference to FIG. 31.

A channel including a chamber can be incorporated on a substrate with detection of magnetically sensitive particles in fluid within the channel. Magnetically sensitive particles can travel through the channel. In the presence of a magnetic field, the magnetically sensitive particle can move to the chamber portion of the channel. This can localize where the magnetically sensitive particles are located within the channel. A chamber/channel in which the magnetically sensitive particles are positioned in can be localized. There can be several receivers on a substrate. As the magnetic field changes, a chamber can fill with magnetically sensitive particles or magnetically sensitive particles can be transferred from one chamber to another. Magnetically sensitive particles can be detected, for example, optically or mechanically. Optical detection can be implemented with higher accuracy in certain applications. When a magnetic field is no longer present, magnetically sensitive particles can be released and reset.

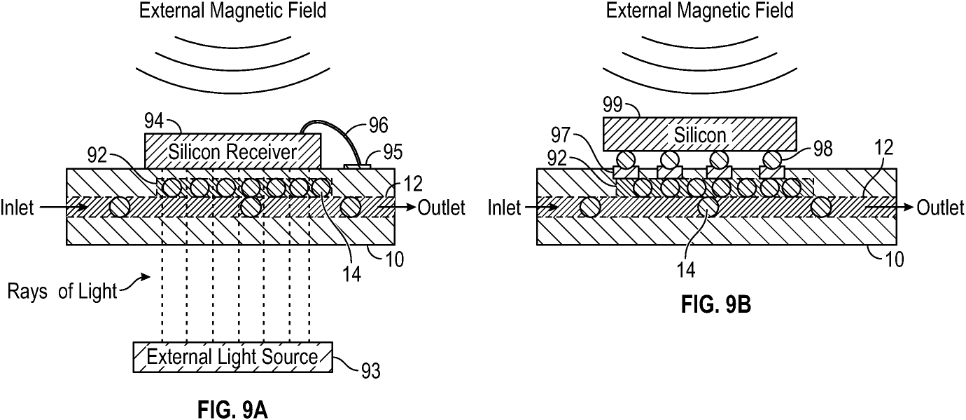

FIGS. 9A and 9B are cross-sectional schematic diagrams with magnetically sensitive particles 14 in channels 12 with integrated detection according to embodiments. In these embodiments, a channel 12 is included in a substrate 10. The channel 12 includes a chamber 92 at a particular location. The substrate 10 can be a glass substrate, for example. The magnetically sensitive particles can flow from an inlet to an outlet. An external magnetic field can move magnetically sensitive particles 14 to the chamber 92 for detection. Such a magnetic field can move magnetically sensitive particles 14 vertically along a defined path into the chamber 92.

In the system of FIG. 9A, optical detection is implemented. In FIG. 9A, a light emitter 93 emits light, and a receiver 94 on the substrate 10 detects magnetically sensitive particles based on light detected from the light emitter 93. The light emitter 93 can approach the magnetically sensitive particles 14 from various angles. The receiver 94 can be a silicon receiver. The receiver 94 can be any other suitable light detector. The receiver 94 can be electrically connected to a trace 95 on the substrate by way of a wire bond 96. Such an electrical connection can alternatively or additionally be made by other suitable electrical connection, such as a bump, a conductive trace, conductive paste, or another suitable medium depending on the specifications of a particular application. This can provide an electrical connection to other circuitry. Positions of magnetically sensitive particles can be detected optically. As a magnetic stimulus is applied (e.g., an external magnetic field), magnetically sensitive particles 14 within fluid can move into the chamber 92. The positions of the magnetically sensitive particles 14 can affect light transmission patterns between the light emitter 93 and the receiver 94. With optics, a measurement associated with the magnetic field (e.g., location of a magnetic field) and/or positions of the magnetically sensitive particles 14 can be determined. Optical detection can detect displacement and/or position of magnetically sensitive particles based on any suitable movement of a magnetic body or other magnetic field source.

Mechanical detection is implemented in the system illustrated in FIG. 9B. In FIG. 9B, conductive vias 97 and interconnects 98 can be connected to an integrated circuit 99 to detect the magnetically sensitive particles 14. The magnetically sensitive particles 14 can be electrically conductive. The positions of the magnetically sensitive particles 14 can be measured based on contact with conductive structures, such as the conductive vias 97. This can sense conductance and/or any other suitable property indicative of the magnetically sensitive particles 14 being in contact with conductive structures. The integrated circuit 99 can detect such contact. The integrated circuit 99 can include a silicon die, for example. The integrated circuit 99 can include any suitable circuitry to detect the magnetically sensitive particles 14 in the chamber 92.

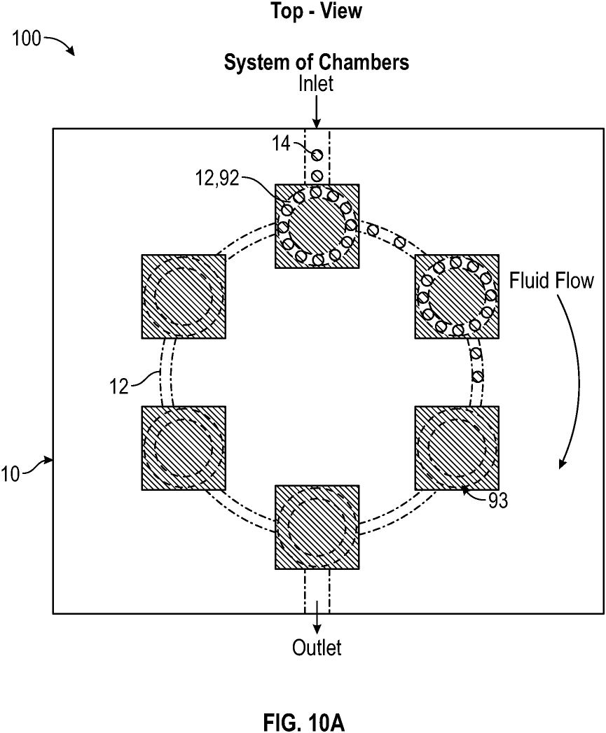

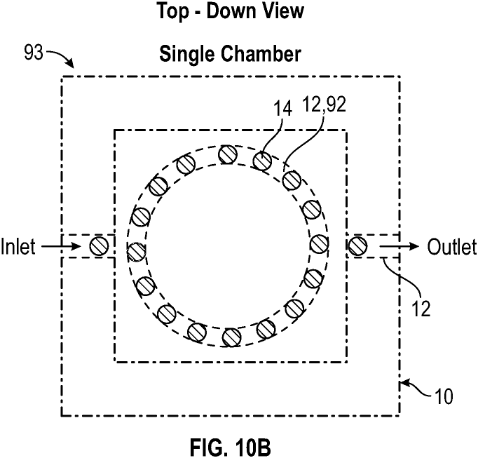

FIG. 10A is a schematic diagram of system 100 with magnetically sensitive particles 14 flowing through a channel 12 with a plurality of chambers 92 according to an embodiment. The channel 12 can be in a substrate 10, such as a glass substrate. In the system 100, magnetically sensitive particles 14 can enter by way of an inlet. Fluid can flow within the channel 12 to move the magnetically sensitive particles 14 along the channel 12. The channel 12 includes chambers 92 positioned at certain locations. A receiver 93, such as a silicon receiver, can be located by each chamber 92 to detect magnetically sensitive particles 14, for example, as discussed with reference to FIG. 9A. A light source 93 can be included for the entire system 100 or each individual chamber 92 to detect the displacement of the magnetically sensitive particles 14. FIG. 10B is a schematic diagram corresponding to one chamber 92 of the system 100 of FIG. 10A. Any suitable chamber 92 designs can be implemented. Any suitable channel 12 designs, such as meandering channel designs, can be implemented.

The different connected chambers 92 shown in FIG. 10A can contain different particle sizes so that each individual, connected chamber 92 can have different sensitivities. In some cases, this can provide the capability to detect different levels of magnetically sensitive particles within fluid. In an application where fluid passing through the system being monitored might is undergoing an aging and/or maturing process, such a process can be tracked. An interaction producing a discernible response between the fluid and each chamber 92 can infer a material property at that specific point. A light source 93 can be included for the entire system 100 or each individual chamber 92 to detect the size/shape of the magnetically sensitive particles 14. The different connected chambers 92 can provide iterative analysis and/or interactive points for analysis with the fluid passing through the system 100. This can be desirable in a variety of applications.

The system 100 can be used in a locking mechanism and/or an accurate location/sensing application. For example, the system 100 can be used in an automatic car charging port. In this example, a magnetic field can be generated by one or more elements in a vehicle charging port. A robotic arm can align when magnetically sensitive particles are in a desired location. Incorporating more chambers and/or channels can make detection of alignment more accurate. Magnetic sensing can be implemented in such a system. Magnetic sensing can reduce noise and wear and tear in some applications relative to other sensing.

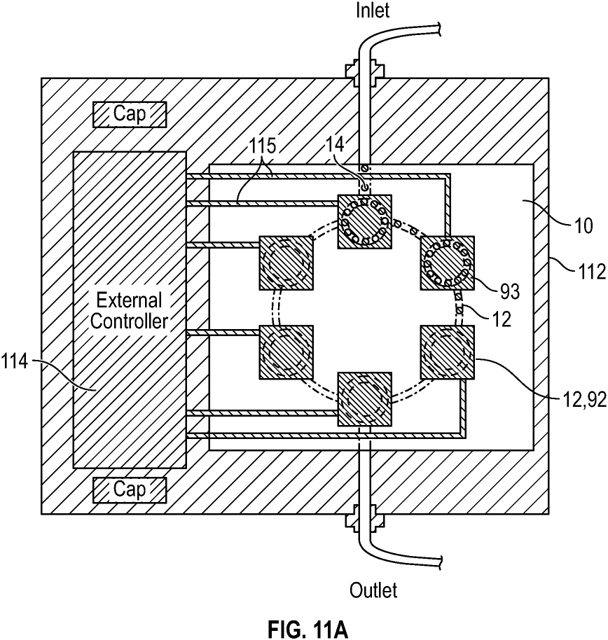

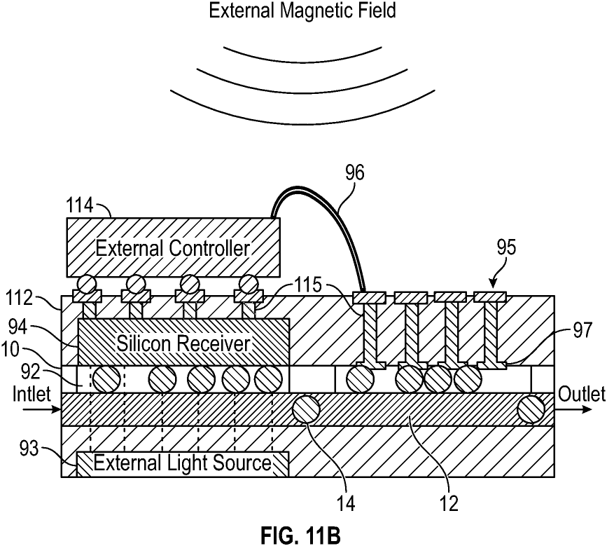

FIG. 11A is a schematic diagram of a printed circuit board 112 and a controller 114 integrated with channels 12 and optical sensing of magnetically sensitive particles 14 according to an embodiment. A laminate/build up structure can be implemented in place of the printed circuit board 112. Such a laminate/build up structure can include glass, ceramic or one or more other suitable materials. The substrate 10 with the channel 12 can be embedded within or otherwise integrated with a printed circuit board 112. The printed circuit board 112 can be a laminate substrate, and the substrate 10 can be a glass substrate. The substrate 10 can be on a top layer in lower layers of the printed circuit board 112. A controller 114 can be in communication with receivers 93 via traces 115. The controller 114 can determine whether magnetically sensitive particles 14 are present in particular chambers 92 based on outputs from particular receivers 93. The controller 114 can be implemented on the printed circuit board 112 as illustrated.

FIG. 11B is a schematic cross-sectional view that shows mechanical and optical detection can also be performed with the system that includes chambers 92 embedded within the printed circuit board 112. The magnetic field will affect the magnetically sensitive particles 14 through the printed circuit board 112. Any other suitable substrate can be implemented in place of the printed circuit board 112. Electrical connections to a sensor, an ASIC, or another device can be made by a wire bond 96 and/or any other suitable electrical connection, such as a bump, a conductive trace, conductive paste or another suitable medium, depending on the specifications of a particular application.

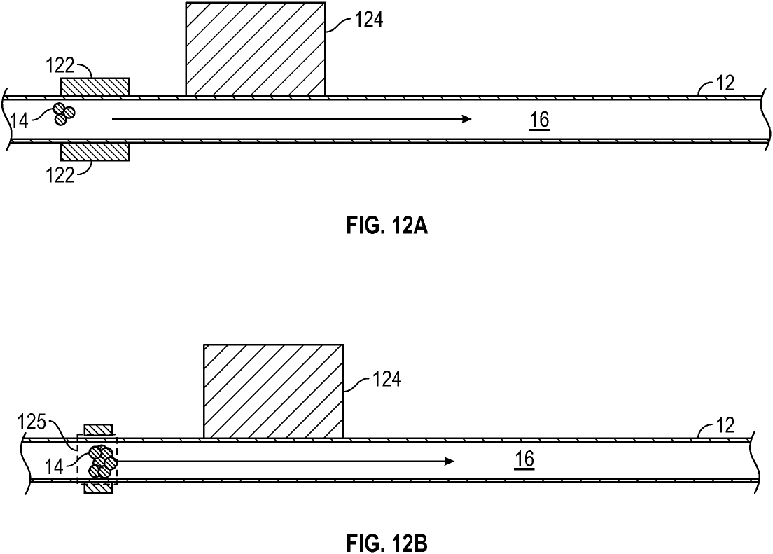

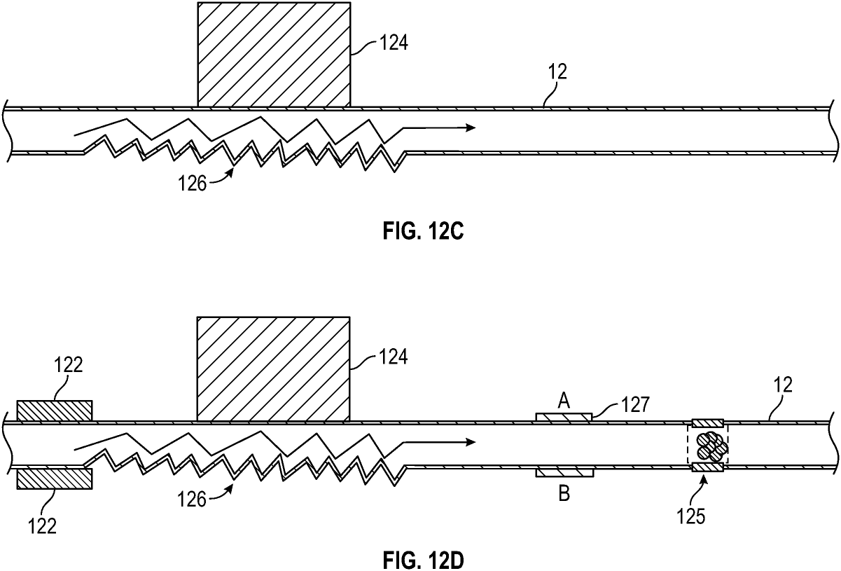

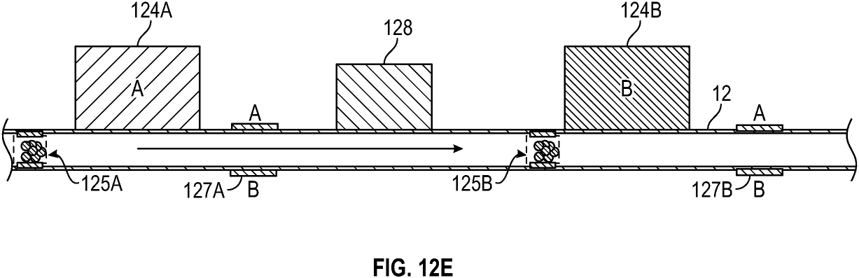

FIG. 12A is a schematic diagram of a channel 12 with an integrated element to move magnetically sensitive particles and an integrated sensing element according to an embodiment. A magnetic structure 122 can apply a magnetic field on magnetically sensitive particles 14 within fluid 16 in the channel 12. The magnetic structure 122 can include a conductive meander structure arranged to apply a varying magnetic field. The magnetic structure 122 can include one or more coils to apply a magnetic field. As the magnetically sensitive particles 14 and the fluid 16 flow through the channel 12, a sensor 124 can detect motion of the magnetically sensitive particles 14. The sensor 124 can include a MEMS sensor. The sensor 124 can include an accelerometer. The sensor 124 can include any suitable sensor configured to sense vibration, motion and/or position of magnetically sensitive particles 14 within the channel 12. The sensor 124 can be positioned at a location relative to a region of the channel 12 where motion, vibration, and/or turbulence is to be detected. The sensor 124 can detect turbulence in the channel 12. The turbulence can be indicative of one or more of magnetic particle content, flow, viscosity, fluid pressure, or the like. The system can be constructed such that the detection of a property related to the movement of the magnetically sensitive particles 14 infers a fluid or process stage property. For example, the sensor 124 can be tuned to detect movement of a specific particle size. As Another example, the actual particle size of the magnetically sensitive particles 14 can be constructed such that the movement within the channel 12 can be detected by the sensor 124. Aspects of the system (e.g., one or more of sensitivity of the sensor 124, channel size, location of the sensor 124, or size and/or shape of the magnetically sensitive particles 14) can be optimized depending on the specifications of a particular application.

FIG. 12B is a schematic diagram of a channel 12 with an integrated agitation structure 125 to agitate fluid 16 in the channel 12, an integrated magnetic structure 122 to apply a magnetic field, and an integrated sensor 124 according to an embodiment. The agitation structure 125 can include magnetically sensitive particles 14 contained in a section of the channel 12 to agitate fluid at a specific area of the channel 12. In the embodiment shown, magnetically sensitive particles 14 are contained within a specific area of the channel 12. The particles can be manipulated such that they can agitate or manipulate the fluid 16 at one or more specific locations. The particles may be contained within a mesh or membrane or constricted region of the channel 12 that ensures that they are physically constrained within a defined area and can be manipulated by structures located in proximity. Fluid 16 can still progress through the channel 12, e.g., through the agitation structure 125. These structures can facilitate analysis of the fluid 16 and/or provide a step as part of a maturing process within a system. The component parts of the system (e.g., size of particles, mesh, membrane, magnetic structures, etc.) can be optimized depending on the specifications of the system.

A channel 12 can incorporate a topography and/or ridges to manipulate fluid 16. These structures can be incorporated as part of the channel design and can be located within one or more defined regions or portions of a channel depending on the specifications of a particular application. FIG. 12C is a schematic diagram of a channel 12 having a channel structure 126 that agitates fluid in the channel 12 and an integrated sensor 124 according to an embodiment. The channel structure 126 can be shaped to create turbulence that is detected by the sensor 124. If, for example, properties of the fluid flowing through the channel 12 (e.g., one or more of pressure, flow rate, viscosity, etc.) changes, this change can be detected by a change in an output of the sensor 124. In some applications (e.g., pharmaceutical, safety etc.), detecting fluid property changes is desirable. In certain applications, the turbulence can function as a bias for sensing with the sensor 124.

A channel structure 126 can be implemented together with other integrated elements, such as a structure to agitate magnetically sensitive particles, magnetic sensing structures, etc. FIG. 12D is a schematic diagram of a channel 12 with a plurality of integrated structures according to an embodiment. A magnetic structure 122 is integrated with the channel 12 to apply a magnetic field. The channel 12 has a channel structure 126 to agitate the fluid in the channel 12. A sensor 124 is arranged for motion sensing and/or sensing magnetically sensitive particles. An electrical parameter sensor 127 can sense an electrical parameter indicative of a material property measured between points. An agitation structure 125 is also included in the channel 12 shown in FIG. 12D.

The construction of a microfluidic channel and the sensitivity of a MEMs sensor or other sensor can be arranged to achieve a variety of advantages. For example, such a construction can detect one or more of viscosity, pressure, or flow rate by movement of a MEMS device. As another example, such a construction can measure viscosity that is indicative of the state of a material, for example, in a process where the fluid evolves and/or changes. As one more example, such a construction can be included at different stages of a process and relative viscosities, flow rates, pressure, or the like can be measured and/or compared. As yet another example, in such a construction, measurements outside certain set threshold(s) and/or level(s) can be wirelessly transmitted to indicate to take action.

FIG. 12E is a schematic diagram of a channel 12 with a plurality of integrated structures according to another embodiment. As illustrated in FIG. 12E, there are agitation structures 125A, 125B, sensors 124A, 124B, and electrical parameter sensors 127A, 127B, and a process stage element 128 integrated with the channel 12. The process stage element 128 can implement heating and/or another treatment stage applied to the fluid within the channel 12. The integrated elements can be included to monitor different stages of a process. The integrated elements can be included for determining relative measurements at different points of the channel 12. At the same time, the fluid can progress through the channel 12. The process stage element 128 can implement heating, mixing, and/or a treatment stage applied to fluid within the channel 12. Different elements can be incorporated and optimized depending on the specifications of the system.

Cumulative magnetic field exposure can be determined based on positions of magnetically sensitive particles in a channel. Systems can register if magnetic field exposure has exceeded a certain threshold in a passive way. Whether a device has been exposed to a relatively strong magnetic field can be detected even after the relatively strong magnetic field has been applied. This can be used to assess if a device has been exposed to a strong magnetic field even if the magnetic field is no longer present. Cumulative magnetic field exposure detection can be performed using magnetically sensitive particles in fluid within a channel.

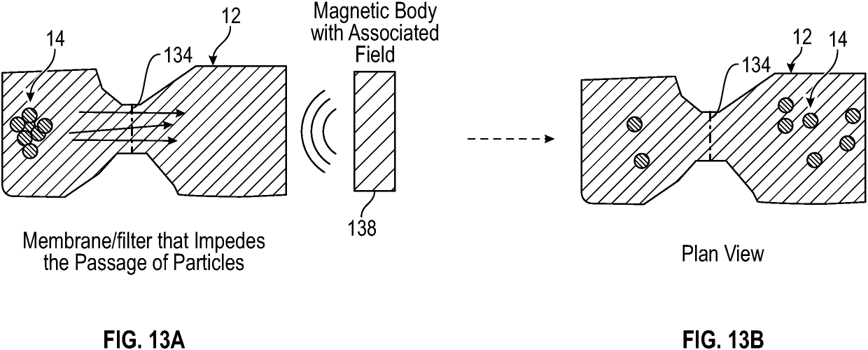

FIGS. 13A and 13B illustrate a schematic diagram of a system with cumulative magnetic field exposure detection according to an embodiment. The system can provide a measure of magnetic field “dose” or field strength integrated over time. The system includes a channel 12 including a flow restriction structure 134 that impedes passage of magnetically sensitive particles 14 therethrough. The flow restriction structure 134 can be semipermeable such that it is easier for particles to flow in one direction than in the opposite direction. The flow restriction structure 134 can be a membrane or a mesh or another suitable structure that restricts particle movement from one region to another within the channel 12. The flow restriction structure 134 can be a filter. In some embodiments, the flow restriction structure 134 can simply be a constriction of flow path cross section.

The magnetically sensitive particles 14 can be in an initial position shown in FIG. 13A. In the illustrated initial position, the magnetically sensitive particles 14 are at or near one end of the channel 12. A reset mechanism can be implemented with the system of FIGS. 13A and 13B. The reset mechanism can cause the magnetically sensitive particles 14 to be at the initial position. A magnetic field source 138 applying a sufficiently strong magnetic field can cause at least some of the magnetically sensitive particles 14 to pass through the flow restriction structure 134. Then the magnetically sensitive particles 14 that have passed through the flow restriction structure 134 can be detected. Such detection can involve optical detection or any other suitable detection mechanism depending on the application.

FIG. 13B illustrates a state where some of the magnetically sensitive particles 14 have passed through the flow restriction structure 134. Based on the positions of magnetically sensitive particles 14 that have passed through the flow restriction structure 134, a measurement circuit can generate an indication of a cumulative magnetic field exposure. The measurement can be generated after the sufficiently strong magnetic field is applied. The measurement can be generated while no magnetic field is being applied.

### Movement of Magnetically Sensitive Particles in Channels

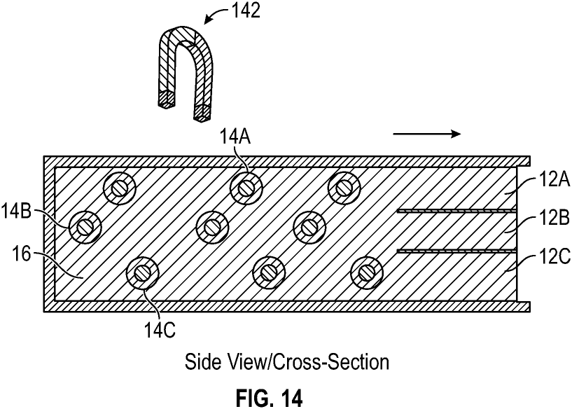

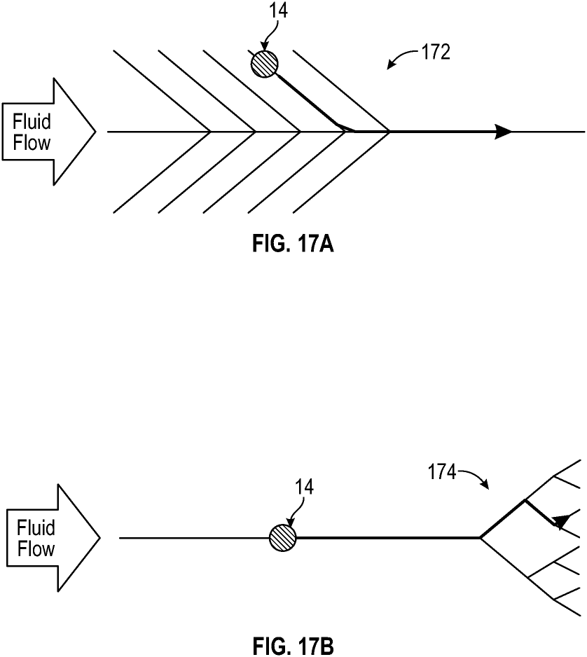

Magnetically sensitive particles can move within channels in a variety of different ways. In some applications, magnetically sensitive particles can be separated into channels by an applied magnetic field. Magnetically sensitive particles can be moved along a defined particle path in certain applications. Such magnetically sensitive particles can be moved from a reservoir to a destination. A gradient magnetic field can be applied to move the magnetically sensitive particles along a channel. The channel can include structures to concentrate and/or to distribute the magnetically sensitive particles. Example embodiments related to moving magnetically sensitive particles within a channel will be discussed with reference to FIGS. 14 and 17B. Any suitable principles and advantages of these embodiments can be implemented together with each other and/or with other embodiments disclosed herein.

FIG. 14 is a schematic diagram of a device where magnetically sensitive particles 14A, 14B, and 14C within fluid 16 can be separated into different channels 12A, 12B, and 12C. A magnetic field can be applied by a magnetic field source 142. This can cause different magnetically sensitive particles 14A, 14B, and 14C to move into different respective channels 12A, 12B, and 12C. Accordingly, the different magnetically sensitive particles 14A, 14B, and 14C can move along different defined paths in response to a magnetic stimulus. The different magnetically sensitive particles 14A, 14B, and 14C can have different properties such they move into different respective channels 12A, 12B, and 12C. For example, the magnetic field can impact magnetically sensitive particles 14A, 14B, and 14C differently. Examples of such different properties include density, magnetic field sensitivity, response to magnetic field (e.g., being attracted or repelled), and the like. One or more of the shape, relative position, gradient, opening dimensions, size or more or more other factors related to 12A, 12B and 12C can be optimized depending on the specifications of a particular application. Particle separation into different channels or paths can be implemented together with any suitable principles and advantages disclosed herein.

In certain applications, a channel can define a route that magnetically sensitive particles can follow. Such a channel can implement a racetrack memory structure. Position of the magnetically sensitive particles in the channel can store an indication of magnetic field exposure. The channel can implement a predefined route. The channel can alternatively implement a programmable route. A reservoir can hold magnetically sensitive particles. The magnetically sensitive particles can be ordered. Alternatively, the magnetically sensitive particles can be unordered. The magnetically sensitive particles can be moved from the reservoir to the channel. By flipping a magnetic moment in the channel, one or more magnetically sensitive particles can be moved forward along the channel. An on chip magnetic structure can generate a magnetic field to implement magnetic moment flipping. Magnetoresistive layers can control transport of magnetically sensitive particles within a channel. This can implement flow control. Magnetically sensitive particles can deliver another substance in certain applications.

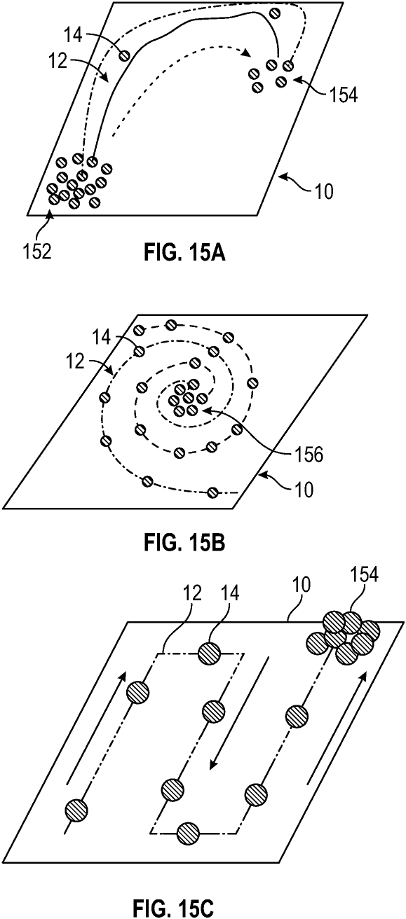

FIGS. 15A, 15B, and 15C are schematic diagrams of channels providing various defined paths for magnetically sensitive particles. As shown in FIG. 15A, magnetically sensitive particles 14 can move from a particle reservoir 152 along a particle path of the channel 12 on a substrate 10 to a particle destination 154 in response to an applied magnetic field. The location(s) of magnetically sensitive particle(s) 14 can be indicative of an applied magnetic field. FIG. 15B illustrates different channels 12 than FIG. 15B. Magnetically sensitive particles 14 can be transported to different channels 12 from a common reservoir. Magnetically sensitive particles 14 can move along different channels 12 to a common destination. A common particle area 156 in FIG. 15B can be a reservoir or a destination. FIG. 15C illustrates another example channel 12 through which magnetically sensitive particles 14 can move along a channel 12 to a destination 154. A magnetic structure to generate a magnetic field to move the magnetically sensitive particles 14 in fluid along a channel 12 can be implemented in and/or on substrate 10 in FIGS. 15A, 15B, and 15C.

The embodiments of FIGS. 15A to 15C enable sorting and/or segregating capabilities that can be incorporated within microfluidic systems. These embodiments can be used where relatively small amounts of particles are to be detected and/or where a process is attempting to segregate particles as part of a treatment step in preparing a sample to be analyzed further in a subsequent step. Also, where small samples are being analyzed, the ability to manipulate, agitate, and/or segregate at the micro level as part of an analytical process may be desirable. Magnetic fields can be used to create “virtual” paths that move particles to different and/or specific locations depending on their characteristics. The magnetic fields can be changed dynamically so that different targets or paths can be generated. This can be used, for example, to guide and/or manipulate bacteria that are functionalized by adding elements sensitive to magnetic fields. The density of a ferromagnetic fluid can also be modified by segregating and/or discriminating particles contained within the fluid, even if particles are not magnetically sensitive provided that the particles have a different density. The dynamic capabilities described in the different embodiments in this application (e.g., through applying varying magnetic fields in conjunction with at least a combination of applying fields at different physical locations and different physical constructions) provide a variety of different methods of constructing systems to interact with fluids in tracks and channels.

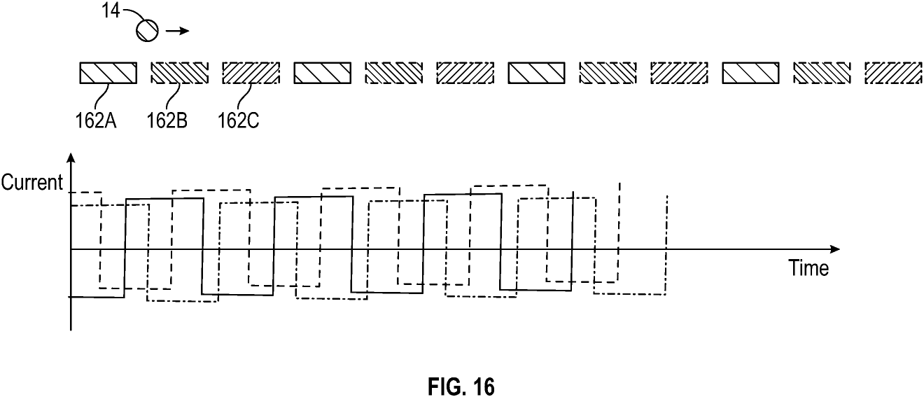

FIG. 16 includes schematic and timing diagrams related to generating a magnetic field gradient for moving magnetically sensitive particles. Wires can have two or more current phases to generate a gradient magnetic field. FIG. 16 illustrates wires 162A, 162B, and 162C with 3 different respective current phases that generate a gradient magnetic field that causes a magnetically sensitive particle 14 to move along a channel.

Channels can include various channel structures to concentrate and/or distribute magnetically sensitive particles. FIG. 17A is a schematic diagram of a channel structure 172 to guide and concentrate magnetically sensitive particles 14 in fluid. For example, a ferromagnetic fish bone structure is illustrated that can guide and concentrate magnetically sensitive particles. The channel structure 172 includes a plurality of sub-channels that feed into a main channel to concentrate magnetically sensitive particles. The structure can be modified and/or optimized depending on the specifications of a particular application.

FIG. 17B is a schematic diagram of a channel structure 174 to guide and distribute magnetically sensitive particles 14 in fluid. The illustrated channel structure 174 can distribute magnetically sensitive particles approximately equally along branches of the channel. The channel structure 174 includes a plurality of sub-channels that branch from a main channel to distribute magnetically sensitive particles. The structure can be modified and/or optimized depending on the specifications of a particular application.

### Channels With Integrated Structures for Heating And/or Agitation

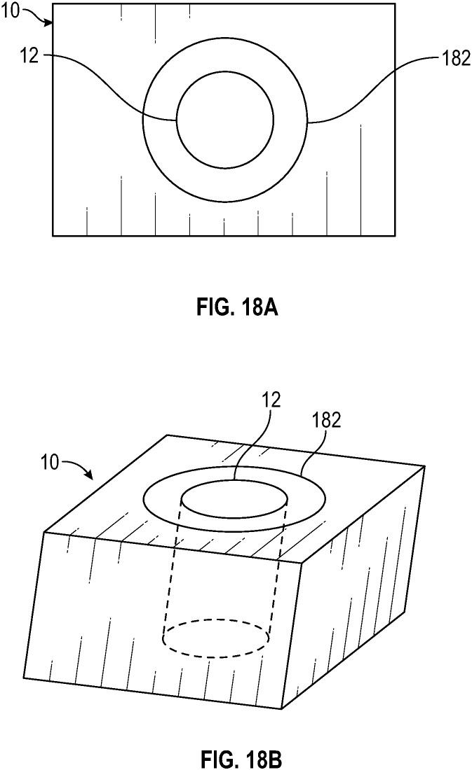

Channels including magnetically sensitive particles in fluid can include integrated structures for heating and/or agitation. A heating element can heat the fluid. In some applications, the heating element can change viscosity of the fluid. This can enable the magnetically sensitive particle to move and/or change the rate at which the magnetically sensitive particles in the fluid move in response to a stimulus. This can be included as part of a treatment or analysis process. A piezoelectric element could physically agitate the fluid to reset positions of magnetically sensitive particles or otherwise cause the magnetically sensitive particles to move, which can be desirable in a variety of applications. The integrated structures can provide a reset mechanism in certain applications. Example structures incorporated with a channel will be discussed with reference to FIGS. 18A to 24D. Any suitable principles and advantages of these embodiments can be implemented together with each other and/or with other embodiments disclosed herein.

FIGS. 18A and 18B are schematic diagrams of a system with a channel 12 and an integrated structure 182 according to an embodiment. FIG. 18A is a plan view. The integrated structure 182 can be located around a cross section of a channel 12. As illustrated, the integrated structure 182 is positioned around an opening of the channel 12. The integrated structure 182 can surround the opening of the channel 12 as illustrated. The integrated structure 182 can include a heating element, such as a resistive heating element. Alternatively or additionally, integrated structure 182 can include a piezoelectric structure. Different structures can be constructed combining different elements including heating, piezoelectric, agitation, etc. depending on the specifications of a particular application.

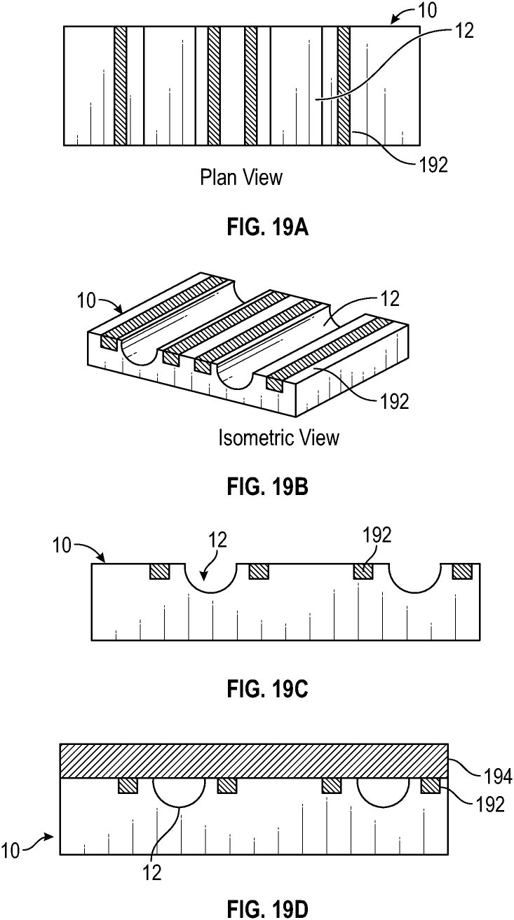

FIGS. 19A to 19D are schematic diagrams of a system with channels 12 and an integrated structure 192 according to an embodiment. In these embodiments, the integrated structure 192 extends along the channel 12. The integrated structure 192 can be on opposing sides of the channel 12. The channels 12 and integrated structure 192 can both be implemented on a substrate 10. The channels 12 can be shaped to implement a desired fluid flow. The integrated structure 192 can include a heating element and/or a piezoelectric element. A cap 194 can be attached to seal a top of the channels 12. The cap 194 can be silicon or glass or ceramic or a polymer or another suitable material forming a protective layer.

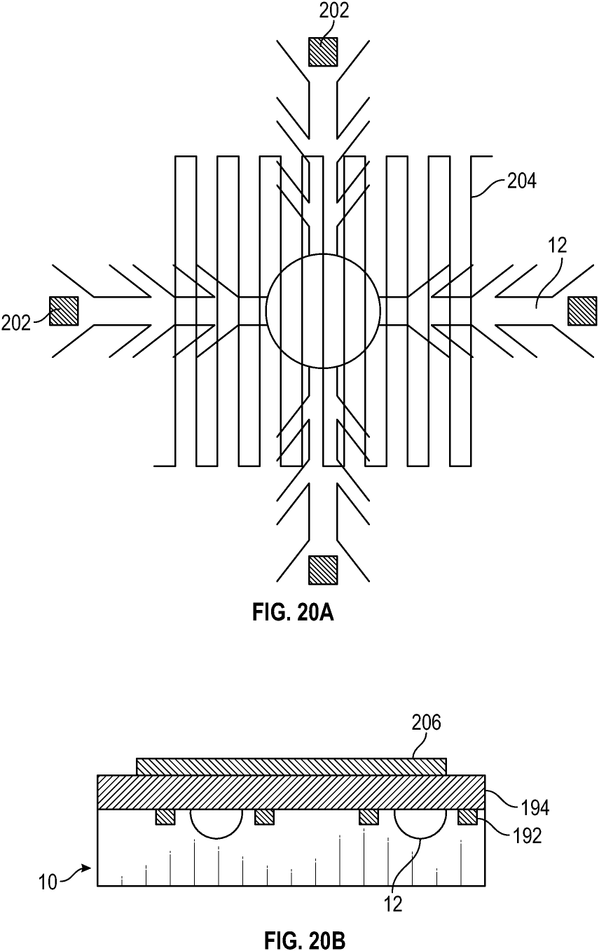

FIG. 20A is a schematic plan view of a channel 12 with a sensor 202 and a meander structure 204 according to an embodiment. The sensor 202 can detect a property of fluid and/or magnetically sensitive particles within the fluid in a specific area of a channel 12. In an embodiment, the sensor 202 can include an optical detector. The sensor 202 can be positioned in a plane adjacent to the channel 12, for example, as illustrated. The meander structure 204 can impart a varying magnetic field to the channel. The meander structure 204 can be positioned in a plane adjacent to the channel 12.

The sensor 202 and/or meander structure 204 can be implemented together with an integrated structure, such as the integrated structure 182 and/or 192. The shape and construction of the system shown can be optimized depending on the specifications of a particular application. FIG. 20B is a schematic cross-sectional view of a channel 12 with an integrated structure 192 and a structure 206 on a cap 194 according to an embodiment. The structure 206 can be deposited on the cap 194. The structure 206 can otherwise be integrated with the cap 194. The structure 206 on the cap 194 can include one or more of a sensor, a meander structure, a piezoelectric structure, a heating element, a MEMS structure, or the like. For example, the structure 206 on the cap 194 can include the meander structure 204 and/or the sensor 202 of FIG. 20A.

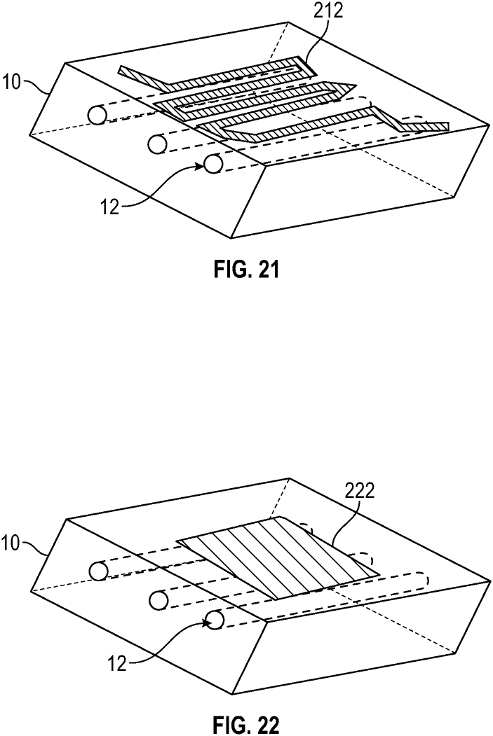

FIG. 21 is a schematic isometric diagram of system with a heating element 212 integrated with a channel 12 according to an embodiment. As illustrated, a substrate 10 includes a plurality of channels 12 and the heating element 212 is included on a layer adjacent to the channels 12. The heating element 212 can be included on and/or within one or more layers of the substrate 10. The heating element 212 can be located in any suitable position relative to the channel 12, such as over and/or under the channel 12. The heating element 212 can be a resistive heating element, for example. Heat generated by the heating element 212 can raise the temperature of fluid within the channel 12. This can adjust viscosity of the fluid, which can in turn impact mobility of magnetically sensitive particles in the fluid. In certain applications, the heating can adjust a physical phase of the fluid.

FIG. 22 is a schematic isometric diagram of system with a piezoelectric element 222 integrated with a channel 12 according to an embodiment. The piezoelectric element 222 is an example of an integrated reset mechanism. The piezoelectric element 222 can include piezoelectric material included on and/or within one or more layers of the substrate 10. The piezoelectric element 222 can be located in any suitable position relative to the channel 12, such as over and/or under the channel 12. The piezoelectric element 222 can be activated to physically agitate magnetically sensitive particles in fluid within the channel 12. This agitation can reset the positions of the magnetically sensitive particles. A combination of a reset mechanism and a heat source, such as the piezoelectric element 222 of FIG. 22 and the heating element 212 of FIG. 21, can be employed in separate layers in and/or on the substrate 10. Agitation can increase the sensitivity of detecting movement of the magnetically sensitive particles in certain applications.

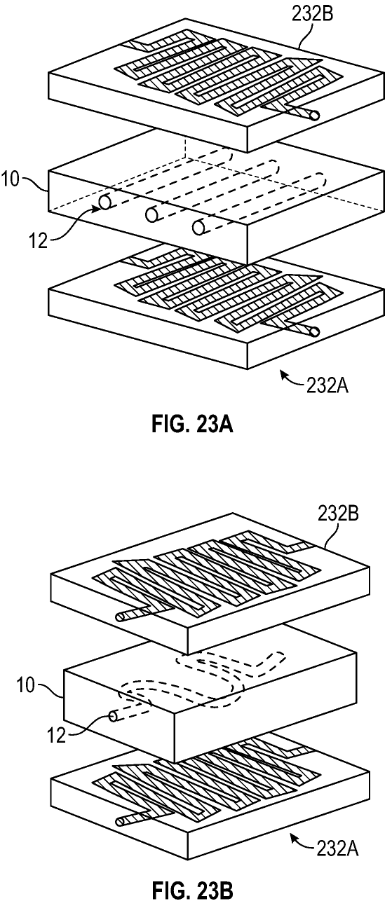

FIGS. 23A and 23B are schematic isometric exploded diagrams of systems with heating elements 232A and 232B on opposing sides of a substrate 10 with one or more channels 12 according to embodiments. Heating elements 232A and 232B on opposing sides of the substrate 10 can provide relatively even heating of fluid within a channel 12. In these embodiments, heating elements 232A and 232B can be implemented in layers above and below one or more channels 12. As illustrated in FIG. 23A, heating elements 232A and 232B can be positioned on opposing sides of a substrate 10 with a plurality of channels 12. Such heating elements 232A and 232B can provide heating for multiple channels 12. As illustrated in FIG. 23B, heating elements 232A and 232B can be positioned on opposing sides of a substrate 10 with a single channel 12.

### Channels With Multiple Integrated Structures

Channels can have multiple integrated structures in some applications. Such structures can provide a variety of functionalities in association with a channel with magnetically sensitive particles in fluid.

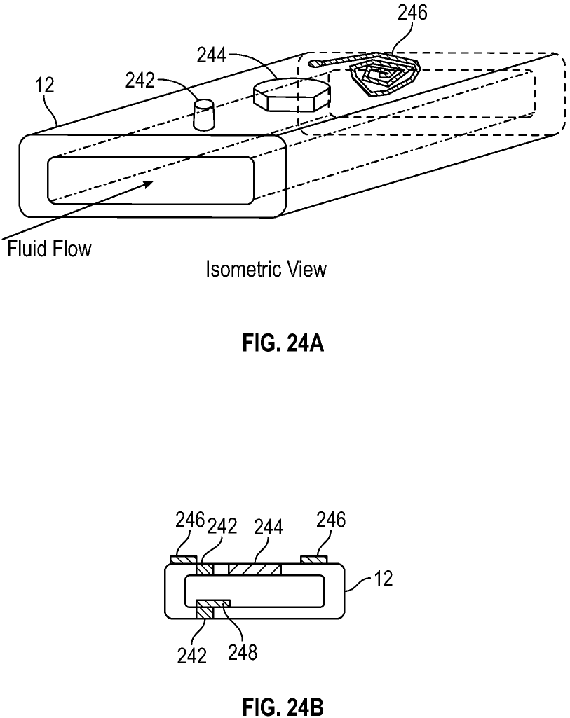

FIGS. 24A and 24B are schematic isometric and cross-sectional views of example channels 12 with a plurality of integrated structures according to embodiments. The integrated structures can interact with magnetically sensitive particles within fluid in a channel 12. As illustrated, a conductive feature 242, an optical window 244, and a trace 246 are integrated with the channel 12 in FIGS. 24A and 24B. In FIG. 24B, a conductive trace 248 is included within the channel 12. The conductive feature 242 can be a via or conductive trace embedded in the structure of the channel 12. The conductive feature 242 can extend through a wall of the channel 12. The conductive feature 242 can provide an electrical connection from inside of the channel 12 to external to the channel 12. For example, the conductive feature 242 electrically connects conductive trace 248 in the channel 12 with trace 246 that is outside of the channel 12 in FIG. 24B. The optical window 244 can provide a window for optical detection of magnetically sensitive particles in the channel 12. The optical window 244 can be embedded in the structure of the channel 12. The trace 246 can be a conductive trace or conductive coil integrated with the channel. As illustrated in FIGS. 24A and 24B, the trace 246 can be on an outer surface of the channel 12. The trace 246 can apply a magnetic field, be a sensing structure (e.g., magnetic or conductive sensing structure), provide signal routing, or facilitate wireless communication. More than one of any of the illustrated structures in FIG. 24A and/or FIG. 24B can be implemented in various applications.

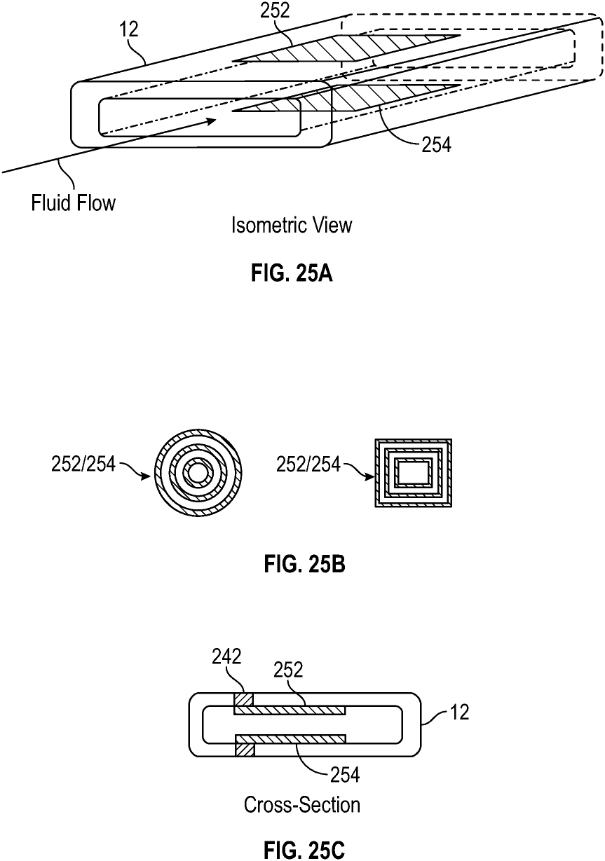

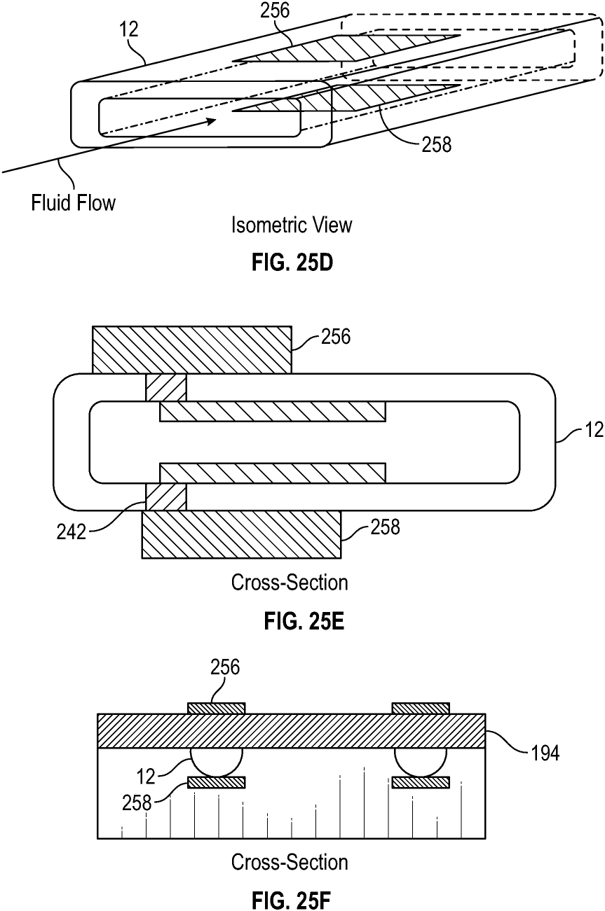

FIGS. 25A, 25C, 25D, 25E, and 25F are schematic views of example channels 12 with integrated conductive structures or sensors according to embodiments. Conductive structures 252 and 254 can be located on an inner surface of these example channels 12. FIG. 25B illustrates example conductive structures 252, 254. The conductive structures 252, 254 can be coil shaped, spiral shape, include concentric shapes, or the like. The conductive structures 252, 254 can have any suitable pattern or shape for a particular application. The conductive structures 252 and/or 254 can detect and/or manipulate magnetic particles within the channel 12. As illustrated in FIG. 25C, a conductive feature 242 can provide an electrical connection from the conductive structure 252 or 254 and to an element or feature outside of the channel 12.

In FIGS. 25D and 25E, a fluid property between sensing elements 256 and 258 can be measured and/or magnetically sensitive particles can be detected. The sensing elements 256 and 258 can detect a change in one or more of conductivity, magnetic field intensity, pH, or the like. For example, a fluid in the channel 12 between sensing elements 256 and 258 can have a dielectric constant. The dielectric constant of the fluid can change by having more or fewer magnetically sensitive particles located between the sensing elements 256 and 258. As the dielectric constant changes, a discernible electrical change between the sensing elements 256 and 258 that can be measured in certain applications. In some other applications, sensing elements 256 and/or 258 can implement optical detection. An optical source, such as a broadband light source or a fixed wavelength laser, can emit light and a sensing element 256 and/or 258 can be an optical detector, such as a photodiode detector. The optical detector can detect magnetically sensitive particles in these applications. In some instances, there can be also a reference channel to calibrate out any drift inaccuracies. The reference channel can be used with any suitable sensing modality.

FIG. 25F illustrates that sensing elements 256 and 258 can be implemented with multiple channels 12. These channels 12 can be monitored at the same time. The channels 12 can be monitored at specific points. A cap 194 and channels 12 can be integrated with and/or connected to sensing elements 256 and 258 to enable the fluid and/or magnetically sensitive particles within the fluid that is passing through the channel 12 to be monitored. The cap 194 can seal some or all of a channel 12. As shown in FIG. 25F, one sensing element 256 can be implemented on the cap 194 and another sensing element 258 can be implemented within the channel 12.

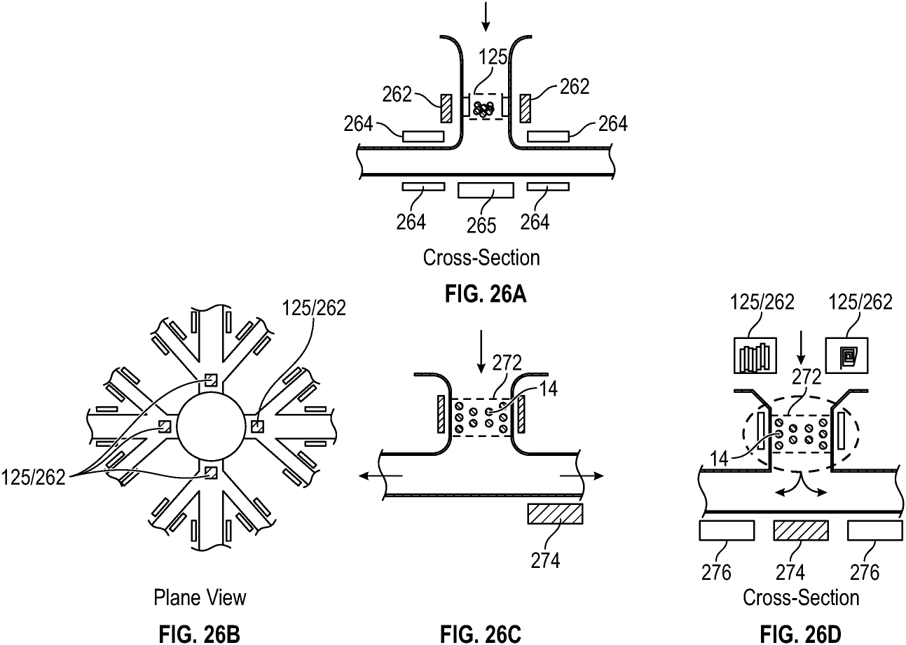

FIGS. 26A to 26D are schematic diagrams of systems with a channel and an agitation or mixing element and other integrated elements according to embodiments. The fluid can be an analyte with magnetically sensitive particles. In addition to gravity, magnetically sensitive particles can be manipulated to move and/or mix the fluid. In the embodiments of FIGS. 26A to 26D, analyte can be agitated through a vertical channel. Additional integrated structures can be included for particular applications. For example, certain applications can include integrated elements to heat the fluid, sense a magnetic or electrical property, the like, or any suitable combination thereof.

FIG. 26A illustrates a vertical sample inlet where an agitation structure 125 can agitate or mix fluid as the fluid enters a channel. A force imparting structure 262, such as meander structure or piezoelectric structure, can be positioned around the channel to apply a force to the magnetically sensitive particles within fluid. A plurality of other elements 264, 265 can be integrated with the channel. The other elements 2624, 265 can include one or more heating elements, one or more magnetic sensing structures, one or more meander structures, one or more optical sensing structures, one or more magnetic structures, one or more electrical sensing structures, or any suitable combination thereof.

FIG. 26B illustrates a vertical drop for analyte with magnetically sensitive particles in a mesh or other constraint. A plurality of structures can be integrated with the channel, such as one or more agitation structures 125 and/or one or more force imparting structures 262.

FIG. 26C illustrates a channel with a vertical inlet with a mesh or other constraint 272 that includes magnetically sensitive particles 14 and other integrated structures. The agitation structure 125 can be activated intermittently. A magnetic body 274 can cause magnetically sensitive material to flow one way in the channel and non-magnetically sensitive material to flow another way in the channel.

FIG. 26D illustrates a channel with a vertical inlet with a mesh or other constraint 272 that includes magnetically sensitive particles 14 and other integrated structures. In FIG. 26D, magnetic sensors 276, such as anisotropic magnetoresistive (AMR) sensors, can be implemented.

### Channels With Filters

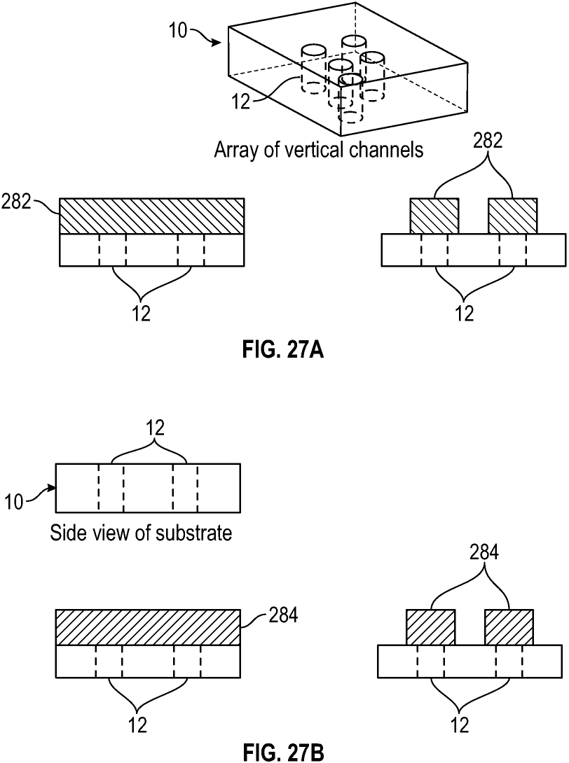

FIGS. 27A and 27B are schematic views of example vertical channel arrays with filters or covers according to embodiments. A substrate can include a vertical channel array. The vertical channel array can be incorporated into a composite or embedded system. As illustrated in FIG. 27A, a filter 282 can be included on a side of a substrate 10 and over an end of a channel 12. The filter 282 can impede magnetically sensitive particles from exiting the channel. The filter 282 can alternatively or additionally keep external material outside of the channel 12. In some instances, filters can be positioned over opposing ends of a channel. FIG. 27B illustrates that a gel, semi-permeable member, electroactive polymer, or other cover 284 can be positioned on a side of the substrate 10 and over an end of a channel 12. This can retain magnetically sensitive particles within the channel 12 and/or keep external material out of the channel 12.

### Magnetically Sensitive Particles

Magnetically sensitive particles 14 can have one or more properties such that the magnetically sensitive particles move in a desired way in response to a magnetic stimulus. For example, magnetically sensitive particles can be constructed, shaped, patterned, or the like so the magnetically sensitive particles respond to a magnetic stimulus in a desired way. As one example, a spiral shaped magnetic particle can respond to a magnetically induced force and move through fluid differently than a spherical or square shaped particle. The viscosity of the fluid and the shape of the magnetically sensitive particle can be balanced for movement of the magnetic particle in response to an applied magnetic field. The magnetically sensitive particles can be coated with an electrically conductive material (e.g., gold) such that when a certain amount of particles cluster or align, a conductive path is formed between electrical contacts in a container. The magnetically sensitive particles can be coated with a coating to enhance optical detection, such as a coating to achieve one or more of a desired optical contrast, color, fluorescence, luminescence, or another optical property. Magnetically sensitive particles can be implemented in accordance with any suitable principles and advantages disclosed in U.S. Pat. App. No. 17/933,600 and/or U.S. Pat. App. No. 18/053,523.

In some instances, one or more internal sections of a channel can be patterned with magnetic material to detect clusters of particles in specific regions. The shape of magnetically sensitive particles can affect how the magnetically sensitive particles move and cluster in such applications. Depending on the outermost material, magnetically sensitive particles may stick together. In some applications, the magnetically sensitive particles can be coated with a thin material, such as Teflon or another polymer, so that there is little or no potential for the magnetically sensitive particles to stick together and/or cluster for any reason other than a response to a magnetic field or other particle movement stimulus.

Magnetically sensitive particles can be constructed to move and/or respond in different ways. Sensitivity, such as movement, to certain field strengths can be improved with certain particle constructions, shapes, etc. The magnetically sensitive particles can be combined with and/or embedded within non-magnetic material to provide the effect of a partially patterned structure. The combined structure can then be inserted into any suitable fluid.

In some instances, magnetically sensitive particles can include an outer coating that is magnetically sensitive. As an example, magnetically sensitive particles can be a polystyrene bead coated with nickel or another magnetically sensitive material. Such magnetically sensitive particles can have an overall density of magnetic material that is lower than a homogenous sphere of magnetically sensitive material. In some other examples, magnetically sensitive particles can have magnetically sensitive core materials and coatings selected to enhance or inhibit interaction with each other and/or the surrounding fluid. For example, the outer coating could be polystyrene, PTFE, Teflon, or some other polymer that can inhibit particles sticking together other than in a desired way as a response to stimulus from a magnetic field.

In certain instances, magnetically sensitive particles have an electrically conductive outer surface. For example, magnetically sensitive particles can be coated with gold. With such magnetically sensitive particles, an electric contact between two electrodes in the container can be closed.

Magnetically sensitive particles can have a coating with one or more specific optical properties in some applications. With such a coating, one or more of a contrast, a color, luminescence or fluorescence can be achieved. The coating with one or more specific optical properties can aid optical detection of magnetically sensitive particles.

As noted above, magnetically sensitive particles can be ferromagnetic, ferrimagnetic, paramagnetic, or diamagnetic. Diamagnetic particles are repelled by a magnetic field. In contrast, paramagnetic and ferromagnetic particles are attracted by a magnetic field. Paramagnetic materials include metals that are weakly attracted to magnets. Examples of paramagnetic materials include lithium, aluminium, tungsten, platinum, and manganese salts. Ferromagnetic particles include one or more suitable ferromagnetic materials, such as iron, nickel, or cobalt. Examples of diamagnetic materials include graphite, gold, bismuth, antimony, quartz, and silver. In certain applications, magnetically sensitive particles are polystyrene (PS) magnetic particles. Polystyrene magnetic particles can be synthesized by embedding superparamagnetic iron oxide into polystyrene. Polystyrene magnetic particles can be positively charged (e.g., by amine modification), unmodified, or negatively changed (e.g., by carboxyl modification).

The magnetically sensitive particles can have any suitable size for a particular application. In certain applications, magnetically sensitive particles are micrometer scale or larger. In some applications, magnetically sensitive particles are millimeter-scale particles. Magnetically sensitive particles can be larger than millimeter-scale. In certain applications, magnetically sensitive particles can have a particle width in a range from about 50 nanometers to 1 millimeter. In some such applications, particle width can be in a range from about 0.5 micron to 100 microns. In some of these applications, particle width can be in a range from about 0.1 micron to 100 microns.

Magnetically sensitive particles can have a shape to influence their movement and/or orientation in the fluid such that their sensitivity to the magnetic field stimulus is enhanced and/or optimized. In certain applications, it may be desirable to have a non-symmetrical magnetically sensitive particle so that the magnetically sensitive particle moves in a particular way when exposed to a magnetic field. A combination of the shape of the magnetically sensitive particle and how the magnetically sensitive particle is embedded or suspended in a fluid/gel can be receptive to magnetic stimuli in particular directions and/or intensities. A particular particle shape combined with a fluid or gel of a particular viscosity can provide a desired sensitivity to a magnetic stimulus. Different particle sizes and shapes can be combined as desired for a range of target sensitivities within a system.

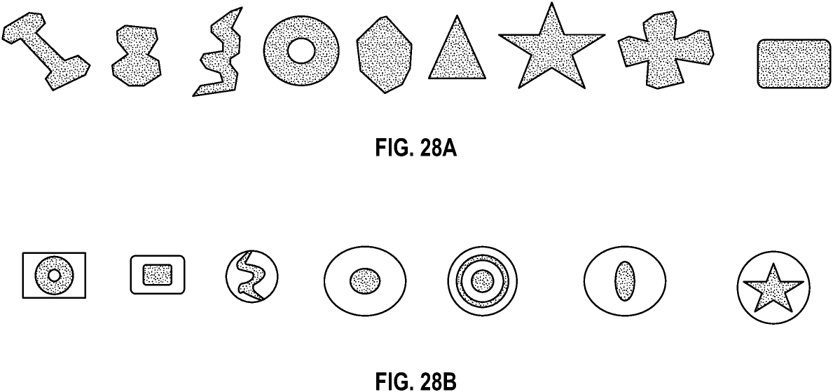

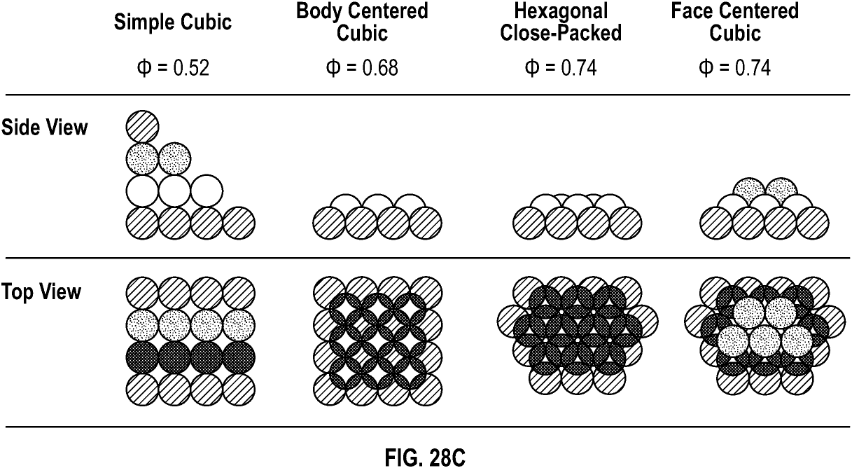

FIG. 28A illustrates example shapes of magnetically sensitive particles. The magnetically sensitive particles can be added to an inert, non-magnetic material to form a combined structure. FIG. 28B illustrates example combined structures with magnetically sensitive particles included within non-magnetic material. Various processes, such as coating, moulding, printing, laser cutting, laminating, and the like, can be used to fabricate composite particles incorporating magnetically sensitive particles so that the magnetically sensitive particles react in a desired manner to a magnetic field. For example, with an outer non-magnetic layer, when a number of the composite particles come together they may be held in a cluster by a magnetic field/force. Such composite particles can have non-magnetic material come into physical contact with one or more other composite particles. Such a construction can be desirable to facilitate release of such composite particles from one another in the absence of the magnetic field. For example, spherical particles with magnetic cores and covered with polystyrene/PTFE may be less likely to stick together and may bounce off each other. A combination of particle shape (e.g., spiral shape, propeller shape, etc.) and fluid viscosity can determine sensitivity and/or speed of a response to a magnetic field stimulus.

Magnetically sensitive particles can have various sizes and densities. If all particles are the same size, a contact surface area can be relatively small. By using a plurality of sizes (e.g., large and small), a bridging structure can have more contact points. This can allow smaller particles to reduce resistance / increase current carrying capability, which may be relevant to some particle movement or position sensing techniques. FIG. 28C shows examples of how combining different types of particles can result in clustering with different shapes, which can be useful for detection purposes.

### Systems and Modules

Systems can include a channel, one or more magnetically sensitive particles within the channel, and one or more structures integrated with the channel. Such systems can detect magnetically sensitive particles within a channel, move magnetically sensitive particles along the channel, otherwise interact with magnetically sensitive particles within the channel, send wireless communications associated with magnetically sensitive particles in the channel, the like, or any suitable combination thereof. The channel can be integrated with, for example co-packaged with, any suitable structures disclosed herein. In some instances, an integrated circuit or other circuitry is integrated with the channel.

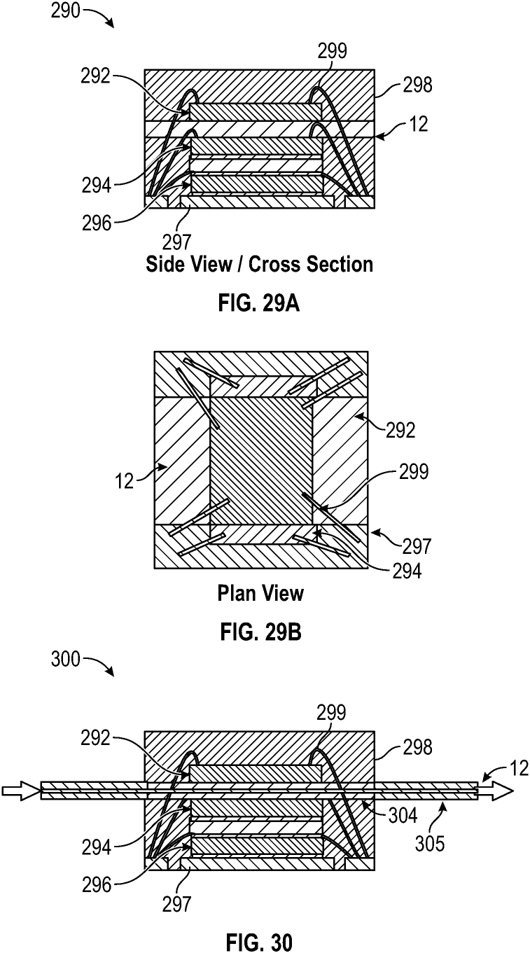

FIGS. 29A to 34 illustrate systems and modules that include a channel containing magnetically sensitive particles in fluid. Any suitable principles and advantages of these embodiments can be implemented together with each other. Moreover, the embodiments of FIGS. 29A to 34 can be implemented with any other suitable principles and advantages disclosed herein related to channels, magnetically sensitive particles, sensing, and/or particles movement disclosed herein.

A channel including magnetically sensitive particles can be included in a system in package (SIP). A SIP is an example of a packaged module. The channel can extend to an edge of the package to an external environment. In certain applications, an agitation or mixing element can be embedded as desired within a SIP to agitate or mix fluid that contains magnetically sensitive particles. The packaging structure can include a molding material, a sealed cavity or “can,” or any other suitable structure to protect integrated circuits.

The magnetically sensitive particles can move within the channel in response to a magnetic stimulus. The magnetic stimulus can be generated by an integrated structure. The magnetic stimulus can be generated external to the SIP. A sensor can be integrated and co-packaged with the channel. A processing die and/or application specific integrated circuit (ASIC) can be included in the SIP. One or more spacers and/or insulating layers can be included in the SIP. FIGS. 29A to 30B illustrate example SIPs according to embodiments.

FIG. 29A is a schematic side or cross-sectional view of a system-in-a-package (SIP) 290 that includes a channel 12 with magnetically sensitive particles in fluid according to an embodiment. FIG. 29B is a schematic plan view of the SIP 290 of FIG. 29A. In the SIP 290, the channel 12 extends to an edge of the package. This can provide an interface between the channel 12 and an external environment. As illustrated, the channel 12 extends horizontally and is vertically integrated with the plurality of die 292, 294, 296 on a package substrate 297. The package substrate 297 can be a laminate substrate or a lead frame fabricated from copper, for example. A package structure 298 can enclose the plurality of die 292, 294, 296 and the channel 12. The package structure 298 can include molding material. The channel 12 is stacked with a plurality of dies 292, 294, and 296. The dies 292, 294, and 296 can be electrically connected to each other and/or contacts of the SIP 290 and/or one or more other element of the SIP 290 by conductive features 299. One or more conductive features 299 can provide electrical connection(s) to a structure of the channel 12. The conductive features 299 can be wire bonds as illustrated. Any other suitable conductive features can alternatively or additionally be implemented. The conductive features 299 can be within the package structure 298. The package structure 298 can be molded or in certain applications a pre-molded cavity package, hermetic cavity package, 3-dimesnational (3D) printed package, or metal. The materials, shape, integration of the channel (from external to internal) and construction of the package can be optimized depending on the specifications of a particular application.

The dies 292, 294, and 296 can include one or more sensors, one or more ASICs, and/or one or more processing dies. The dies 292, 294, and 296 can be semiconductor dies, such as silicon dies. For example, the die 294 can include a sensor and the die 296 can include a measurement circuit configured to process an output of the sensor and generate an output signal associated with a magnetic field and/or positions of the magnetically sensitive particles. This output signal can be provided to a contact of the SIP 290. The output signal can alternatively be wirelessly transmitted by the SIP 290 when the SIP 290 includes an antenna. As another example, the die 294 can include both the sensor and the measurement circuit. As one more example, the die 294 can include a structure to generate a magnetic field (e.g., a meander structure) and the die 296 can include control circuitry to control generation of the magnetic field. In another example, the die 294 can include both the structure to generate the magnetic field and the control structure. In certain applications, a sensor is included in the SIP 290 and not included on any of the dies 292, 294, or 296.

FIG. 30 is schematic side or cross-sectional views of a SIP that include a channel 12 according to an embodiment. In the SIP 300, a spacer layer 304 can include a channel 12 to interact with an external environment. The spacer layer 304 can be an insulating layer. The spacer layer 304 can include another element, such as an optical link, to interact with the external environment. The channel 12 of the SIP 300 can be connected to a connection element 305. The connection element 305 can be a fitting, a tube, a filter, a micro pump, or any other suitable element for a particular application. There can be connections from an external to the SIP 300 to the spacer layer 304. There can also be connections within the vertically integrated elements of the SIP 300. Fluid containing magnetically sensitive particles can be provided to the channel 12 of the SIP 300 for monitoring and/or analysis. The channel 12 can be part of a larger channel that extends outside of the SIP 300, and the SIP 300 can perform sensing and analysis of the fluid flowing through the channel 12 within the SIP 300. FIG. 30 shows the dies and portions of the channel construction encapsulated. In FIG. 30, there are openings for the channel 12 to exit the SIP 300. In some other applications, a system can include a pre-molded cavity package, a hermetic package, a metal can package, a 3D printed package or another suitable package technology depending on the specification of a particular application.

Integrated systems can include a magnet, a channel, and a die. FIG. 31 includes a side view of a system 310 for multi-turn magnetic field sensing according to an embodiment. The system 310 can count rotations of a magnetic field. As illustrated, the system 310 includes a movable magnet 312, a channel 12 arranged as a spiral that includes one or more magnetically sensitive particles in fluid, an ASIC 315, and a leadframe 316. The channel 12 can be included in a substrate 10 on the ASIC 315. The ASIC 315 can be positioned on a leadframe 316. The movable magnet 312 can be connected to a rotatable shaft. As the shaft rotates, a magnetic field generated by the movable magnet 312 can also rotate. This can cause the one or more magnetically sensitive particles to move through the channel 12. The ASIC 315 can include sensors to detect the magnetically sensitive within the channel 12. The ASIC 315 can include a measurement circuit that can determine a turn count indicative of a number of rotations of the magnetic field based on output signals from the sensors. The measurement circuit can output an indication of turn count. The indication of turn count can have any suitable accuracy, such as quarter turn accuracy, half count accuracy, or full turn accuracy. The ASIC 315 can include pump drivers in certain applications. The ASIC 315 can include any suitable circuitry to implement any combination of features discussed with reference to detecting rotations of a magnetic field disclosed herein, such as any combination of features discussed with reference to FIGS. 7A to 8D.

FIG. 32 includes views of a channel 12 with magnetically sensitive particles in an embedded system 320 according to an embodiment. A substrate 10 with channels 12 can be embedded in a laminate or build up substrate 322. As illustrated, the channels 12 are lateral channels. Fluid can enter the channels 12 by way of an inlet conduit 323. The laminate substrate 322 can be a printed circuit board. In the embedded system 320, a sensing element 324, one or more dies 325 (e.g., processing dies or ASICs), and one or more passive or discrete circuit elements 326 can be embedded in the laminate substrate 322. In certain applications, one or more heating elements, one or more piezoelectric elements, one or more other sensing elements, one or more optical systems, or any suitable combination thereof can be embedded in the laminate substrate 322. Elements embedded within the laminate substrate 322 can be electrically connected to each other. For example, the sensing element 324 can be electrically connected to a die 325. The die 325 can process on output signal from the sensing element 324. The die 325 can be electrically connected to an output contact of the embedded system 320 to provide a signal associated with magnetically sensitive particles in the channel 12. The substrate 322 can be fabricated using build up laminate technologies or 3D printing technologies or co-fired ceramic layers or glass or silicon incorporating electroactive polymers or other suitable materials or technologies depending on the specifications of a particular application.

Systems disclosed herein can wirelessly communicate with another device. Such a system can include one or more antennas that can wirelessly transmit an indication of a sensor output and/or another signal associated with one or more magnetically sensitive particles in a channel. The one or more antennas can wirelessly communicate any other suitable information.

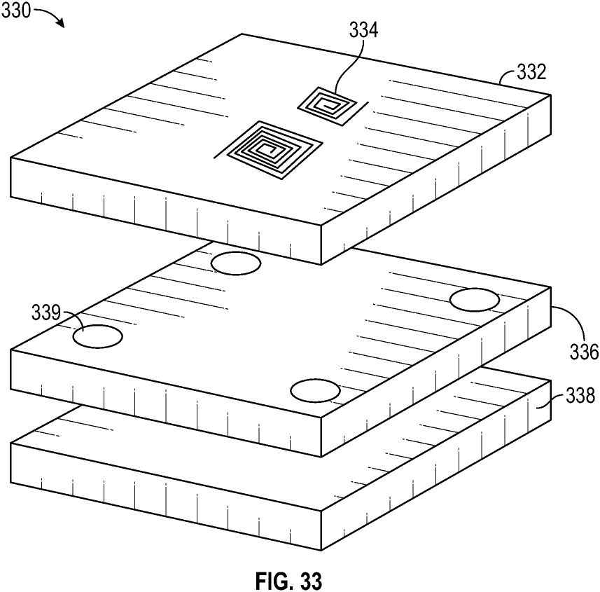

FIG. 33 illustrates an exploded schematic view of an example system 330 with one or more channel with magnetically sensitive particles and wireless communication according to an embodiment. The system 330 can be a measurement system. The system 330 includes a wireless communication layer 332 that includes one or more antennas 334, a layer 336 including a sensor, and a layer 338 that includes at least one channel with magnetically sensitive particles, where the sensor can detect the magnetically sensitive particles in accordance with any suitable principles and advantages disclosed herein. The layer 336 can include a measurement circuit configured to process an output signal from the sensor in certain instances. The layer 338 can include embedded conductive structure and/or any other suitable structures disclosed herein. Conductive vias 339 and/or traces can electrically connect layers of the system 330. The one or more antennas 334 can include a coil, for example. The one or more antennas 334 can be included in a radio frequency identification (RFID) tag. The wireless communication layer 332 can include circuitry to support wireless signal transmission, or such circuitry may be provided in a lower layer, such as the layer 336. In some instances, the wireless communication layer that includes the one or more antennas 334 or other circuitry of the system 330 can encrypt data for transmission via the one or more antennas 334.

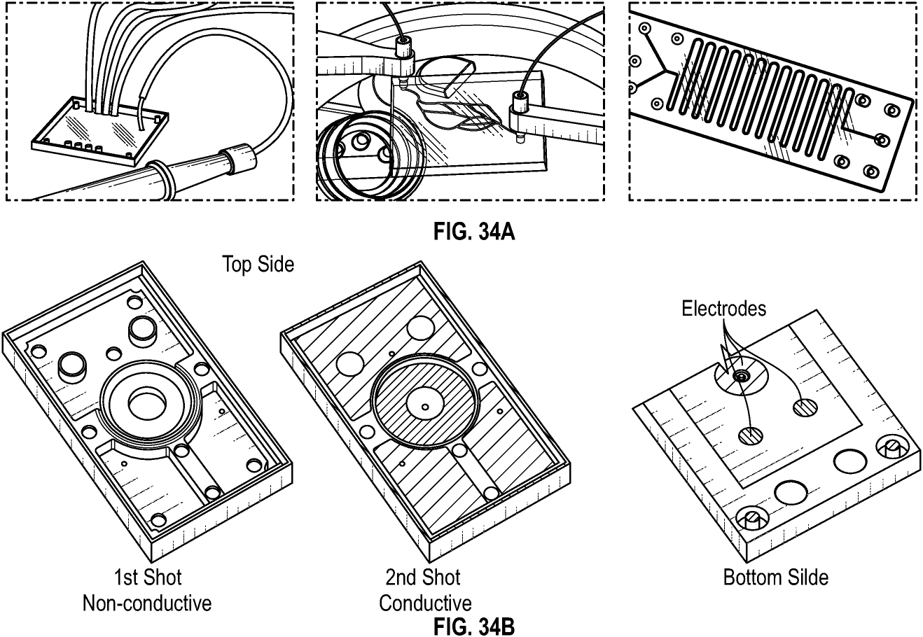

Channels with magnetically sensitive particles in fluid can be included in various modules and substrates. FIG. 34A includes views of substrates with channels according to embodiments. FIG. 34B include views of a substrate according to an embodiment. Such modules and substrates that include channels can be constructed of a variety of different materials, such as glass, plastic, etc. Laminate technology with through module vias, wire bonds, solder bumps or the like can be implemented.

Channels can be formed in a variety of ways. For example, channels of a substrate can use standard tubing and fittings, for example, as illustrated in FIG. 34A. These substrates with channels can be implemented in any suitable system, SIP, or module.

As another example, channels can be formed by injection molding. Such injection moulding can form a substrate, for example. In FIG. 34B, the substrate is formed by injection molding where one side is a non-conductive plastic and the other side is a conductive plastic. Different plastics can be used to injection mold over other components, such as semiconductor components and/or other circuit components. Injection molded plastic can include 2-shot injection molding technology, in which one of the plastics is the ‘fluidic plastic’ and the second plastic is an electrically conductive version of the first plastic. The second plastic can be the same plastic as the first plastic but loaded with stainless steel, graphite, conductive carbon fibers, or another suitable conductive material to make it conductive and define electrodes. The substrate of FIG. 34B with channels can be implemented in any suitable system, SIP, or module.

### Conclusion

In the embodiments described above, apparatus, systems, and methods with one or more magnetically sensitive particles in a channel are described in connection with particular embodiments. It will be understood, however, that the principles and advantages of the embodiments can be used for any other systems, apparatus, or methods with a need for any of the technical features disclosed herein. Moreover, any suitable principles and advantages disclosed herein can be implemented in systems and in methods that relate to a channel with one or more magnetically sensitive particles.

The principles and advantages described herein can be implemented in various apparatuses. Examples of such apparatuses can include, but are not limited to, consumer electronic products, parts of the consumer electronic products, electronic test equipment, vehicular electronic products, industrial electronic products, etc. Further, apparatuses can include unfinished products.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the inventions provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present inventions is defined by reference to the claims.

What is claimed is:

1. A system with particle movement and magnetic field sensing, the system comprising:
a channel comprising a fluid and at least one particle in the fluid, wherein the at least one particle moves along a defined path of the channel in response to a magnetic field; and
a sensor that is integrated with the channel, the sensor configured to generate an output signal related to the magnetic field.

2. The system of claim 1, wherein the at least one particle comprises a magnetically sensitive particle.

3. The system of claim 1, wherein the fluid is a magnetically sensitive fluid.

4. The system of claim 1, further comprising a measurement circuit configured to generate a measurement is indicative of a number of turns of the magnetic field based on the output signal, and the number of turns is greater than one, wherein the channel is spiral shaped.

5. The system of claim 1, wherein the output signal is indicative of a cumulative exposure to the magnetic field.

6. The system of claim 1, wherein the output signal is indicative of position of the at least one particle.

7. The system of claim 1, further comprising a magnetic structure integrated with the channel and an integrated circuit that is integrated with the channel, wherein the integrated circuit is configured to control flow of the at least one particle in the channel by at least providing a signal to the magnetic structure.

8. The system of claim 7, wherein the magnetic structure has a meander shape.

9. The system of claim 1, further comprising a heating structure integrated with the channel.

10. The system of claim 1, further comprising a piezoelectric structure integrated with the channel.

11. The system of claim 1, further comprising an antenna configured to transmit information associated with the output signal of the sensor.

12. A method of measuring one or more particles that move in response to a magnetic stimulus, the method comprising:
providing a channel comprising a fluid and one or more particles in the fluid, wherein the one or more particles move along a defined path of the channel in response to an applied magnetic field; and
generating a measurement related to the one or more particles based on an output of a sensor that is integrated with the channel.

13. The method of claim 12, wherein the channel is spiral shaped, the measurement is indicative of a number of turns of the applied magnetic field, and the number of turns is greater than one.

14. The method of claim 12, wherein the measurement is indicative of a cumulative exposure to the applied magnetic field.

15. The method of claim 12, wherein the measurement is indicative of position of the one or more particles.

16. The method of claim 12, further comprising controlling flow of the one or more particles in the channel by at least providing a signal to a magnetic structure that is integrated with the channel.

17. The method of claim 12, further comprising:
controlling flow of the fluid in the channel as part of an analytic process, wherein the measurement is indicative of progress of the analytic process; and
wirelessly transmitting the measurement via at least one antenna.

18. A system with particle movement in response to a magnetic stimulus, the system comprising:
a channel comprising a fluid and at least one particle in the fluid; and
a magnetic structure integrated with the channel, the magnetic structure comprising a meander shape, and the magnetic structure configured to apply a gradient magnetic field to cause the at least one particle to move in the channel.

19. The system of claim 18, further comprising a sensor integrated with the channel, the sensor configured to generate an output signal related to the gradient magnetic field.

20. The system of claim 18, further comprising at least one of a heating element integrated with the channel or a piezoelectric element integrated with the channel.
